(19) United States
(12) Patent Application Publication
(10) Pub. No.: US 2026/0045185 A1
(43) Pub. Date: Feb. 12, 2026

(54) DISPLAY PANEL, AND PATTERN TEST METHOD FOR A DISPLAY PANEL

(71) Applicant: Samsung Display Co., LTD., Yongin-si (KR)

(72) Inventors: DASOM YANG, Yongin-si (KR); HYUNGJUN PARK, Yongin-si (KR)

(73) Assignee: Samsung Display Co., LTD., Yongin-si (KR)

(21) Appl. No.: 19/211,662

(22) Filed: May 19, 2025

(30) Foreign Application Priority Data
Aug. 12, 2024 (KR) 10-2024-0107495

(51) Int. Cl. G09G 3/00; G09G 3/3233

(52) U.S. Cl. CPC G09G 3/006; G09G 3/3233; G09G 2300/0452; G09G 2300/0819; G09G 2300/0842; G09G 2300/0861; G09G 2310/08; G09G 2330/12

(57) ABSTRACT

A display panel includes a plurality of data lines, a plurality of pixels connected to the plurality of data lines, a lighting test circuit that provides an emission data voltage to the plurality of pixels through the plurality of data lines, and a pattern test circuit that provides a non-emission data voltage to a portion of the plurality of pixels through the plurality of data lines after the emission data voltage is provided to the plurality of pixels such that the plurality of pixels display a pattern image.

### CROSS-REFERENCE TO RELATED APPLICATION(S)

This application claims priority to and benefits of Korean Patent Application No. 10-2024-0107495 under 35 USC § 119, filed on Aug. 12, 2024, in the Korean Intellectual Property Office (KIPO), the entire contents of which are incorporated herein by reference.

### BACKGROUND

### 1. Technical Field

Embodiments relate to a display panel including a pattern test circuit, and a pattern test method for a display panel by using the pattern test circuit.

### 2. Description of the Related Art

A display device may include a display panel that includes multiple pixels, a data driver that provides data signals to the pixels, a gate driver that provides gate signals to the pixels, and a controller that controls the data driver and the gate driver.

When the display device is manufactured, to detect a defect in the display panel, a lighting test, an open-short test, etc. may be performed on the display panel in a cell state before the data driver is connected to the display panel. However, a test (e.g., a pattern test) for detecting an image sticking defect or the like, which occurs after the display panel displays a pattern image, may be performed in a module state in which the data driver is connected to the display panel.

### SUMMARY

Some embodiments provide a display panel on which a pattern test is performed in a cell state.

Some embodiments provide a method of performing a pattern test on a display panel in a cell state.

According to embodiments, a display panel may include a plurality of data lines, a plurality of pixels connected to the plurality of data lines, a lighting test circuit that provides an emission data voltage to the plurality of pixels through the plurality of data lines, and a pattern test circuit that provides a non-emission data voltage to a portion of the plurality of pixels through the plurality of data lines after the emission data voltage is provided to the plurality of pixels such that the plurality of pixels display a pattern image.

In embodiments, the lighting test circuit may provide the emission data voltage to the plurality of pixels arranged in a pixel row in a first period within a horizontal time allocated to the pixel row, and the pattern test circuit may provide the non-emission data voltage to a portion of the plurality of pixels arranged in the pixel row in a second period after the first period within the horizontal time.

In embodiments, the lighting test circuit may include an emission data voltage line that transfers the emission data voltage, and a plurality of lighting test transistors that connect the emission data voltage line to the plurality of data lines in response to a lighting test signal.

In embodiments, the plurality of pixels may include red pixels arranged in a first pixel column, green pixels arranged in a second pixel column, and blue pixels arranged in a third pixel column. The lighting test circuit may include a red emission data voltage line that transfers a red emission data voltage to the red pixels, a green emission data voltage line that transfers a green emission data voltage to the green pixels, a blue emission data voltage line that transfers a blue emission data voltage to the blue pixels, a first lighting test transistor that connects the red emission data voltage line to a data line arranged in the first pixel column among the plurality of data lines in response to a lighting test signal, a second lighting test transistor that connects the green emission data voltage line to a data line arranged in the second pixel column among the plurality of data lines in response to the lighting test signal, and a third lighting test transistor that connects the blue emission data voltage line to a data line arranged in the third pixel column among the plurality of data lines in response to the lighting test signal.

In embodiments, the plurality of pixels may include red, green, blue and green pixels arranged in a first pixel row and arranged in first, second, third, and fourth pixel columns, respectively, and blue, green, red and green pixels arranged in a second pixel row adjacent to the first pixel row and arranged in the first, second, third, and fourth pixel columns, respectively. The lighting test circuit may include a red emission data voltage line that transfers a red emission data voltage, a green emission data voltage line that transfers a green emission data voltage, a blue emission data voltage line that transfers a blue emission data voltage, a first-first lighting test transistor that connects the red emission data voltage line to a data line arranged in the first pixel column among the plurality of data lines in response to a first lighting test signal, a first-second lighting test transistor that connects the blue emission data voltage line to the data line arranged in the first pixel column among the plurality of data lines in response to a second lighting test signal, a second lighting test transistor that connects the green emission data voltage line to a data line arranged in the second pixel column among the plurality of data lines in response to a third lighting test signal, a third-first lighting test transistor that connects the blue emission data voltage line to a data line arranged in the third pixel column among the plurality of data lines in response to the first lighting test signal, a third-second lighting test transistor that connects the red emission data voltage line to the data line arranged in the third pixel column among the plurality of data lines in response to the second lighting test signal, and a fourth lighting test transistor that connects the green emission data voltage line to a data line arranged in the fourth pixel column among the plurality of data lines in response to the third lighting test signal.

In embodiments, the lighting test circuit may receive the first lighting test signal and the third lighting test signal within a first horizontal time for the first pixel row, and may receive the second lighting test signal and the third lighting test signal within a second horizontal time for the second pixel row.

In embodiments, the pattern test circuit may include a non-emission data voltage line that transfers the non-emission data voltage, a plurality of first pattern test transistors that connect the non-emission data voltage line to a portion of the plurality of data lines in response to a first pattern test signal, and a plurality of second pattern test transistors that connect the non-emission data voltage line to a remainder of the plurality of data lines in response to a second pattern test signal.

In embodiments, the lighting test circuit may receive a lighting test signal in a first period within each horizontal time, and the pattern test circuit may receive one of the first pattern test signal and the second pattern test signal in a second period after the first period within the each horizontal time.

In embodiments, the plurality of data lines may include first through M-th data lines arranged in first through M-th pixel columns, respectively, (M+1)-th through 2M-th data lines arranged in (M+1)-th through 2M-th pixel columns, respectively, (2M+1)-th through 3M-th data lines arranged in (2M+1)-th through 3M-th pixel columns, respectively, and (3M+1)-th through 4M-th data lines arranged in (3M+1)-th through 4M-th pixel columns, respectively. M may be an integer greater than 0. The pattern test circuit may include a non-emission data voltage line that transfers the non-emission data voltage, a plurality of first pattern test transistors that connect the non-emission data voltage line to the first through M-th data lines and the (2M+1)-th through 3M-th data lines in response to a first pattern test signal, and a plurality of second pattern test transistors that connect the non-emission data voltage line to the (M+1)-th through 2M-th data lines and the (3M+1)-th through 4M-th data lines in response to a second pattern test signal.

In embodiments, the lighting test circuit may receive a lighting test signal in a first period within each of first through N-th horizontal times allocated to first through N-th pixel rows, (N+1)-th through 2N-th horizontal times allocated to (N+1)-th through 2N-th pixel rows, (2N+1)-th through 3N-th horizontal times allocated to (2N+1)-th through 3N-th pixel rows, and (3N+1)-th through 4N-th horizontal times allocated to (3N+1)-th through 4N-th pixel rows. N may be an integer greater than 0. The pattern test circuit may receive the second pattern test signal in a second period after the first period within each of the first through N-th horizontal times and the (2N+1)-th through 3N-th horizontal times, and may receive the first pattern test signal in a second period after the first period within each of the (N+1)-th through 2N-th horizontal times and the (3N+1)-th through 4N-th horizontal times. The pattern image may be a chess pattern image.

In embodiments, the lighting test circuit may receive a lighting test signal in a first period within each of first through N-th horizontal times allocated to first through N-th pixel rows, (N+1)-th through 2N-th horizontal times allocated to (N+1)-th through 2N-th pixel rows, (2N+1)-th through 3N-th horizontal times allocated to (2N+1)-th through 3N-th pixel rows, and (3N+1)-th through 4N-th horizontal times allocated to (3N+1)-th through 4N-th pixel rows. N may be an integer greater than 0. The pattern test circuit may receive the first pattern test signal in a second period after the first period within each of the first through N-th horizontal times and the (2N+1)-th through 3N-th horizontal times, and may receive the second pattern test signal in a second period after the first period within each of the (N+1)-th through 2N-th horizontal times and the (3N+1)-th through 4N-th horizontal times. The pattern image may be a chess pattern image.

In embodiments, the plurality of data lines may include first through L-th data lines arranged in first through L-th pixel columns. L may be an integer greater than 0. The pattern test circuit may include a non-emission data voltage line that transfers the non-emission data voltage, a plurality of first pattern test transistors that connect the non-emission data voltage line to (K+1)-th through (L−K)-th data lines among the first through L-th data lines in response to a first pattern test signal, and a plurality of second pattern test transistors that connect the non-emission data voltage line to first through K-th data lines and (L−K+1)-th through L-th data lines among the first through L-th data lines in response to a second pattern test signal. K may be an integer greater than 0 and less than L/2.

In embodiments, the display panel may include first through P-th pixel rows. P may be an integer greater than 0. The lighting test circuit may receive a lighting test signal in a first period within each of first through P-th horizontal times allocated to the first through P-th pixel rows. The pattern test circuit may not receive any of the first pattern test signal and the second pattern test signal in each of first through Q-th horizontal times and (P−Q+1)-th through P-th horizontal times among the first through P-th horizontal times, and may receive the first pattern test signal in a second period after the first period within each of (Q+1)-th through (P−Q)-th horizontal times among the first through P-th horizontal times. The pattern image may be an outer line image. Q may be an integer greater than 0 and less than P/2.

In embodiments, the display panel may include first through P-th pixel rows. P may be an integer greater than 0. The lighting test circuit may receive a lighting test signal in a first period within each of first through P-th horizontal times allocated to the first through P-th pixel rows. The pattern test circuit may receive both of the first pattern test signal and the second pattern test signal in each of first through Q-th horizontal times and (P−Q+1)-th through P-th horizontal times among the first through P-th horizontal times, and may receive the second pattern test signal in a second period after the first period within each of (Q+1)-th through (P−Q)-th horizontal times among the first through P-th horizontal times. The pattern image may be a central region image. Q may be an integer greater than 0 and less than P/2.

In embodiments, the plurality of data lines may include first through L-th data lines arranged in first through L-th pixel columns, respectively. L may be an integer greater than 0. The pattern test circuit may include a non-emission data voltage line that transfers the non-emission data voltage, a plurality of first pattern test transistors that connect the non-emission data voltage line to first through (L/2)-th data lines among the first through L-th data lines in response to a first pattern test signal, and a plurality of second pattern test transistors that connect the non-emission data voltage line to (L/2+1)-th through L-th data lines among the first through L-th data lines in response to a second pattern test signal.

In embodiments, the lighting test circuit may receive a lighting test signal in a first period within each horizontal time. The pattern test circuit may receive the first pattern test signal in a second period after the first period within the each horizontal time. The pattern image may be a right region image.

In embodiments, the lighting test circuit may receive a lighting test signal in a first period within each horizontal time. The pattern test circuit may receive the second pattern test signal in a second period after the first period within the each horizontal time. The pattern image may be a right region image.

In embodiments, the display panel may further include an open-short test circuit that alternately provides a first open-short test voltage and a second open-short test voltage to the plurality of data lines. The non-emission data voltage may be the first open-short test voltage of the open-short test circuit.

According to embodiments, a method of performing a pattern test for a display panel may include measuring an initial luminance of the display panel, displaying, by a plurality of pixels of the display panel, a pattern image for a time period by providing an emission data voltage to the plurality of pixels by using a lighting test circuit of the display panel and by providing a non-emission data voltage to a portion of the plurality of pixels that have received the emission data voltage by using a pattern test circuit of the display panel, measuring a final luminance of the display panel, and detecting whether the display panel is defective based on a luminance difference between the initial luminance and the final luminance.

According to embodiments, an electronic device may include a processor that provides image data, and a display device that displays an image based on the image data. The display device may include the display panel.

As described above, in a display panel and a method of performing a pattern test for the display panel according to embodiments, a lighting test circuit may provide an emission data voltage to a plurality of pixels, and a pattern test circuit may provide a non-emission data voltage to a portion of the plurality of pixels. Accordingly, the display panel according to embodiments may display a pattern image in a cell state, and thus a pattern test may be performed on the display panel in the cell state.

### BRIEF DESCRIPTION OF THE DRAWINGS

Illustrative, non-limiting embodiments will be more clearly understood from the following detailed description in conjunction with the accompanying drawings.

FIG. 1 is a schematic diagram illustrating a display panel according to embodiments.

FIG. 2 is a schematic diagram of an equivalent circuit of a pixel included in a display panel according to embodiments.

FIG. 3 is a schematic diagram of an equivalent circuit of a pixel included in a display panel according to embodiments.

FIG. 4 is a schematic diagram illustrating a display panel according to embodiments.

FIG. 5 is a schematic diagram illustrating a display panel according to embodiments.

FIG. 6 is a schematic diagram illustrating a pattern test circuit included in a display panel according to embodiments.

FIG. 7 is a schematic timing diagram for describing an operation of a pattern test circuit included in a display panel according to embodiments.

FIG. 8 is a schematic diagram illustrating a display panel according to embodiments.

FIG. 9 is a schematic timing diagram for describing an operation of a display panel according to embodiments.

FIG. 10 is a schematic diagram illustrating a pattern image displayed by a display panel according to embodiments.

FIG. 11 is a schematic timing diagram for describing an operation of a display panel according to embodiments.

FIG. 12 is a schematic diagram illustrating a pattern image displayed by a display panel according to embodiments.

FIG. 13 is a schematic diagram illustrating a display panel according to embodiments.

FIG. 14 is a schematic timing diagram for describing an operation of a display panel according to embodiments.

FIG. 15 is a schematic diagram illustrating a pattern image displayed by a display panel according to embodiments.

FIG. 16 is a schematic timing diagram for describing an operation of a display panel according to embodiments.

FIG. 17 is a schematic diagram illustrating a pattern image displayed by a display panel according to embodiments.

FIG. 18 is a schematic diagram illustrating a display panel according to embodiments.

FIG. 19 is a schematic timing diagram for describing an operation of a display panel according to embodiments.

FIG. 20 is a schematic diagram illustrating a pattern image displayed by a display panel according to embodiments.

FIG. 21 is a schematic timing diagram for describing an operation of a display panel according to embodiments.

FIG. 22 is a schematic diagram illustrating a pattern image displayed by a display panel according to embodiments.

FIG. 23 is a schematic diagram illustrating a display panel according to embodiments.

FIG. 24 is a schematic timing diagram for describing an operation of a display panel according to embodiments.

FIG. 25 is a schematic diagram illustrating a pattern image displayed by a display panel according to embodiments.

FIG. 26 is a flowchart illustrating a method of performing a pattern test for a display panel according to embodiments.

FIG. 27 is a schematic block diagram illustrating a display device according to embodiments.

FIG. 28 is a schematic block diagram illustrating an electronic device including a display device according to embodiments.

### DETAILED DESCRIPTION OF THE EMBODIMENTS

Hereinafter, embodiments of the disclosure will be explained in detail with reference to the accompanying drawings.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals, reference symbol, and/or reference characters denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Also, when an element is referred to as being “in contact” or “contacted” or the like to another element, the element may be in “electrical contact” or in “physical contact” with another element; or in “indirect contact” or in “direct contact” with another element.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

In the specification and the claims, the phrase “at least one of” is intended to include the meaning of “at least one selected from the group of” for the purpose of its meaning and interpretation. For example, “at least one of A and B” may be understood to mean “A, B, or A and B. ” In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Unless otherwise defined or implied herein, all terms (including technical and scientific terms) used have the same meaning as commonly understood by those skilled in the art to which this disclosure pertains. It will be further understood that terms, such as those defined in commonly used dictionaries, should be interpreted as having a meaning that is consistent with their meaning in the context of the relevant art and should not be interpreted in an ideal or excessively formal sense unless clearly defined in the specification.

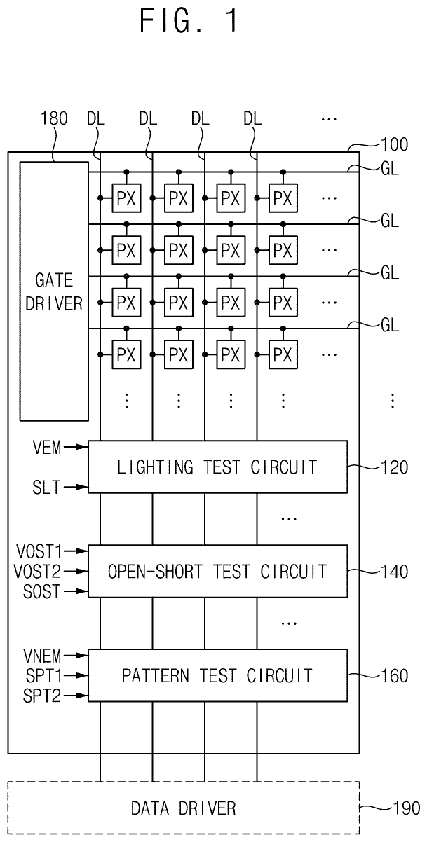

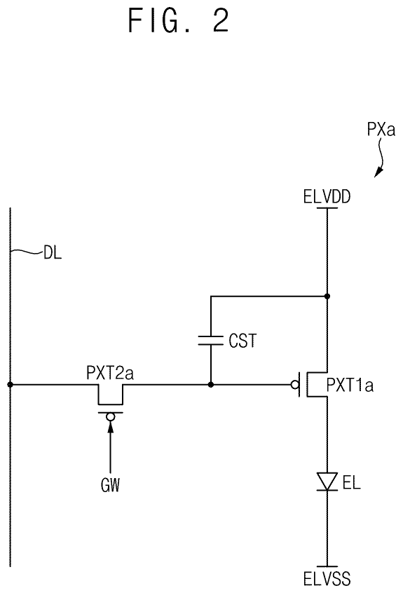

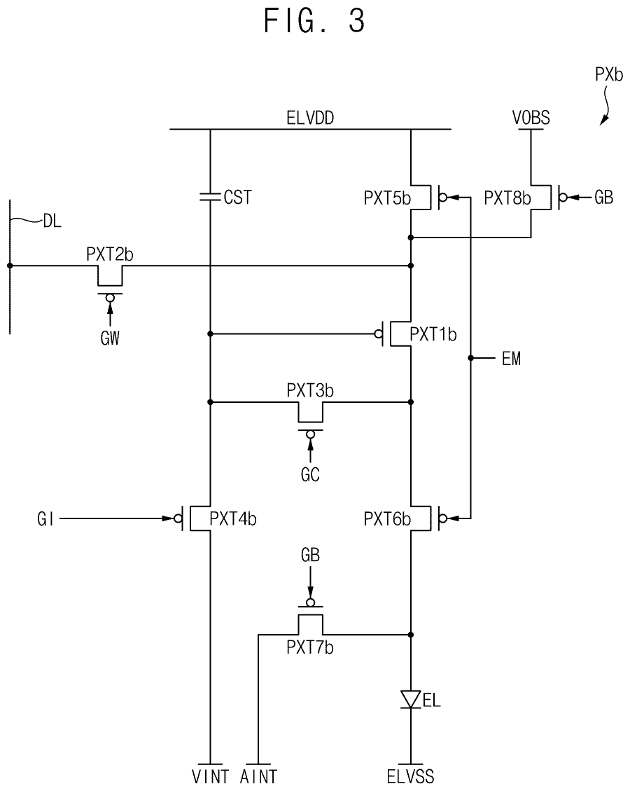

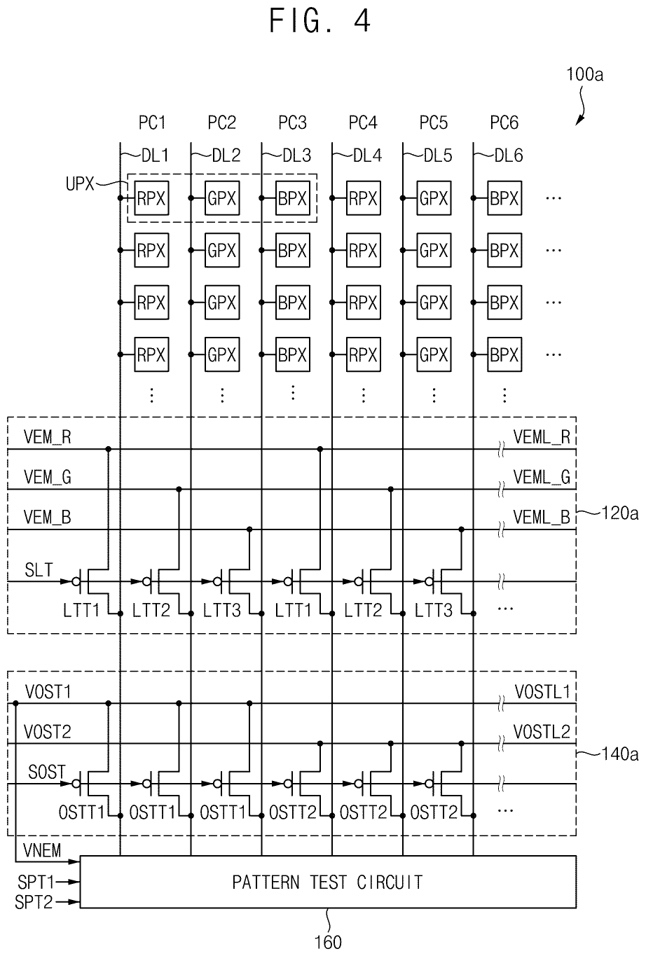

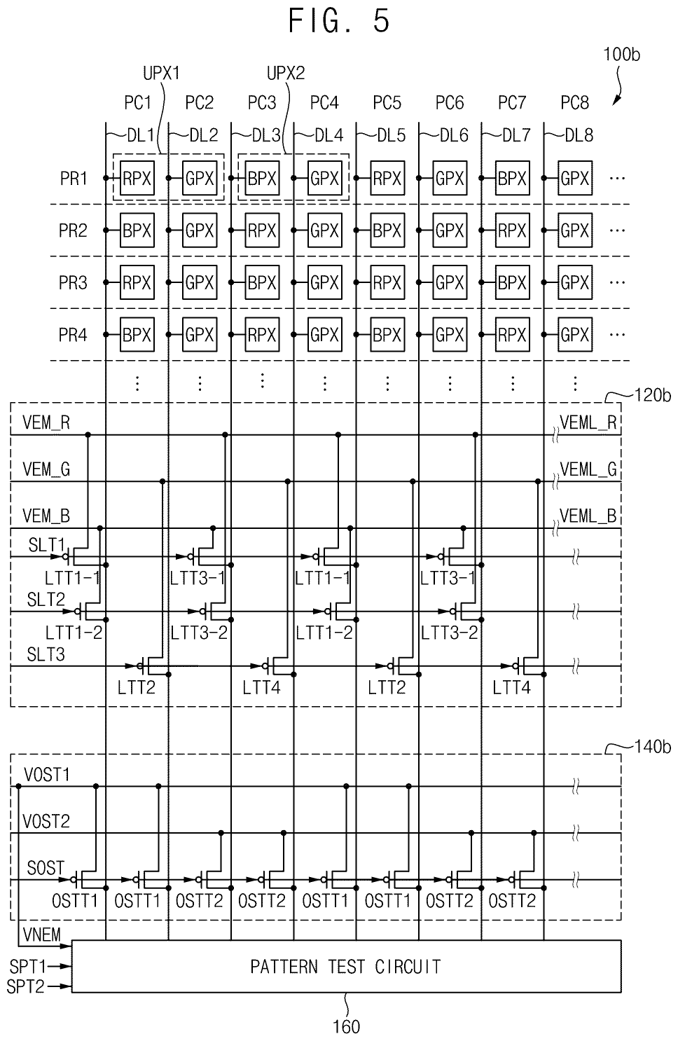

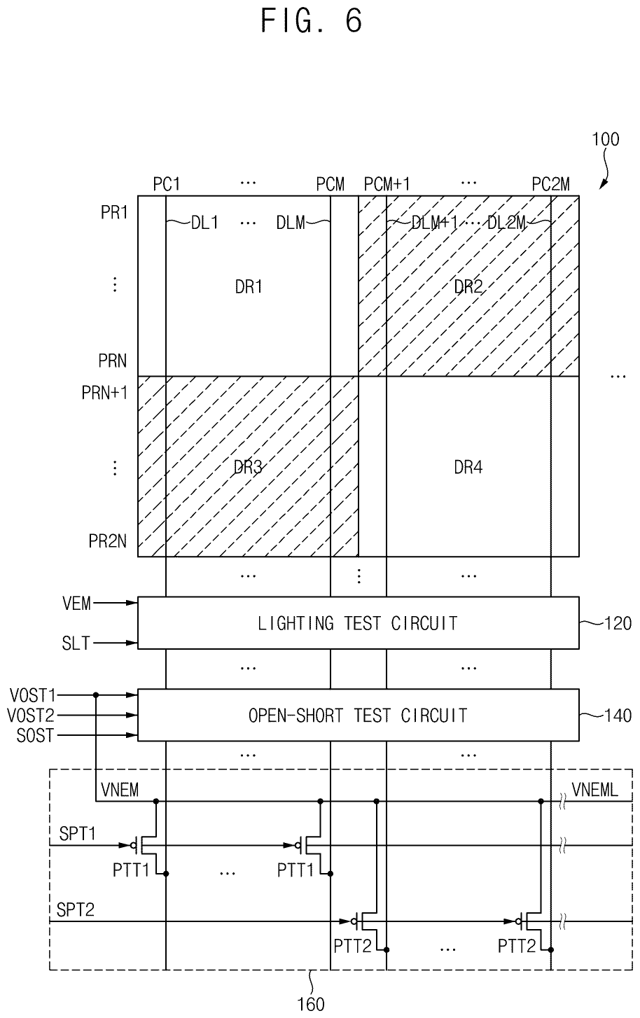

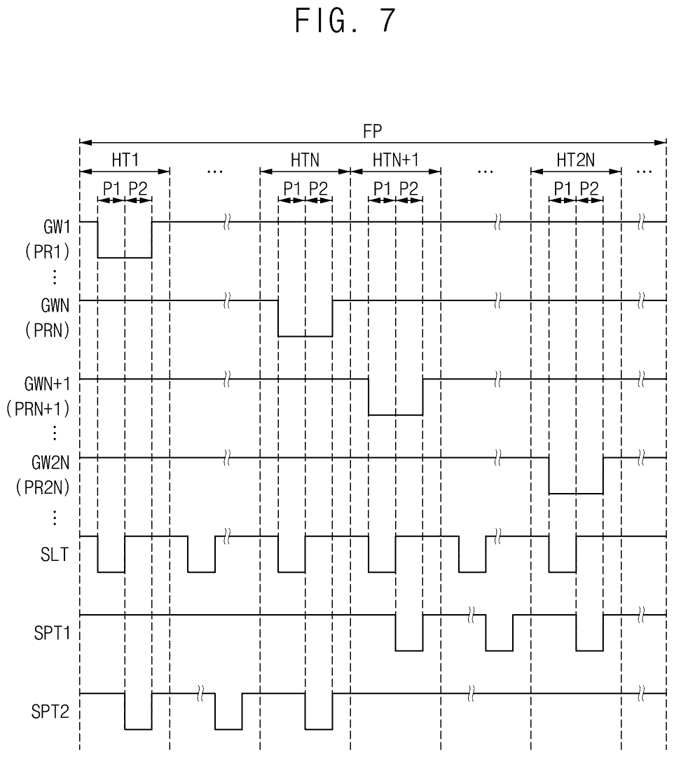

FIG. 1 is a schematic diagram illustrating a display panel according to embodiments, FIG. 2 is a schematic diagram of an equivalent circuit of a pixel included in a display panel according to embodiments, FIG. 3 is a schematic diagram of an equivalent circuit of a pixel included in a display panel according to embodiments, FIG. 4 is a schematic diagram illustrating a display panel according to embodiments, FIG. 5 is a schematic diagram illustrating a display panel according to embodiments, FIG. 6 is a schematic diagram illustrating a pattern test circuit included in a display panel according to embodiments, and FIG. 7 is a schematic timing diagram for describing an operation of a pattern test circuit included in a display panel according to embodiments.

Referring to FIG. 1, a display panel 100 according to embodiments may include multiple data lines DL, multiple pixels PX connected to the data lines DL, a lighting test circuit 120 that provides an emission data voltage VEM to the pixels PX through the data lines DL, and a pattern test circuit 160 that provides a non-emission data voltage VNEM to a portion of the pixels PX through the data lines DL. In some embodiments, the display panel 100 may further include an open-short test circuit 140 that provides a first open-short test voltage VOST1 or a second open-short test voltage VOST2 to the data lines DL. In some embodiments, the display panel 100 may further include multiple gate lines GL, and a gate driver 180 that provides gate signals to the pixels PX through the gate lines GL. In some embodiments, although it is not illustrated in FIG. 1, the display panel 100 may further include a crack detection circuit, a one-sheet test circuit, or the like. Further, in some embodiments, in a cell state before the display panel 100 is connected to a data driver 190, a lighting test, an open-short test, a pattern test, etc. may be performed on the display panel 100.

The pixels PX may be connected to the data lines DL and the gate lines GL. In some embodiments, each pixel PX may include at least two transistors, at least one capacitor and a light emitting element. According to embodiments, the light emitting element may be an organic light-emitting diode (“OLED”), a micro light emitting diode, a nano light emitting diode (“NED”), a quantum dot (“QD”) light emitting diode, an inorganic light emitting diode, or any other suitable light emitting element.

For example, as illustrated in FIG. 2, each pixel PXa may receive a write signal GW as a gate signal, and the pixel PXa may include a second transistor PXT2a that transfers a voltage of the data line DL in response to the write signal GW, a capacitor CST that stores the voltage transferred by the second transistor PXT2a, a first transistor PXT1a that generates a driving current based on the voltage stored in the capacitor CST, and a light emitting element EL that emits light based on the driving current flowing from a line which transfers a first power supply voltage ELVDD (e.g., a high power supply voltage) to a line which transfers a second power supply voltage ELVSS (e.g., a low power supply voltage).

In another embodiment, as illustrated in FIG. 3, each pixel PXb may receive a write signal GW, a compensation signal GC, an initialization signal GI, a bypass signal GB, and an emission signal EM as the gate signals, and the pixel PXb may include a capacitor CST, a first transistor PXT1b, a second transistor PXT2b, a third transistor PXT3b, a fourth transistor PXT4b, a fifth transistor PXT5b, a sixth transistor PXT6b, a seventh transistor PXT7b, an eighth transistor PXT8b, and the light emitting element EL.

The capacitor CST may store a voltage transferred from the data line DL through the second transistor PXT2b and the first transistor PXT1b (that is diode-connected by the third transistor PXT3b). The first transistor PXT1b may generate a driving current based on the voltage stored in the capacitor CST. The second transistor PXT2b may transfer the voltage of the data line DL to a first terminal (e.g., a source) of the first transistor PXT1b in response to the write signal GW. The third transistor PXT3b may diode-connect the first transistor PXT1b in response to the compensation signal GC. The fourth transistor PXT4b may apply an initialization voltage VINT to the capacitor CST and a gate of the first transistor PXT1b in response to the initialization signal GI. The fifth and sixth transistors PXT5b and PXT6b may form a path for the driving current from the line which transfers the first power supply voltage ELVDD to the line which transfers the second power supply voltage ELVSS in response to the emission signal EM. The seventh transistor PXT7b may apply an anode initialization voltage AINT to an anode of the light emitting element EL in response to the bypass signal GB. The eighth transistor PXT8b may apply a bias voltage VOBS to the first terminal (e.g., the source) of the first transistor PXT1b in response to the bypass signal GB. The light emitting element EL may emit light based on the driving current generated by the first transistor PXT1b.

Although FIG. 2 illustrates an embodiment in which the pixel PXa has a 2T1C structure, and FIG. 3 illustrates an embodiment in which the pixel PXb has an 8T1C structure, the pixel PX of the display panel 100 is not limited to the embodiments of FIG. 2 and FIG. 3.

In some embodiments, as illustrated in FIG. 4, a display panel 100a may have an RGB stripe structure in which red pixels RPX, green pixels GPX and blue pixels BPX are respectively arranged in three adjacent pixel columns (e.g., first, second, and third pixel columns PC1, PC2 and PC3). In the display panel 100a, one red pixel RPX, one green pixel GPX and one blue pixel BPX may form one unit pixel UPX or one pixel group. For example, the display panel 100a may include red pixels RPX connected to a first data line DL1 in a first pixel column PC1, green pixels GPX connected to a second data line DL2 in a second pixel column PC2, blue pixels BPX connected to a third data line DL3 in a third pixel column PC3, red pixels RPX connected to a fourth data line DL4 in a fourth pixel column PC4, green pixels GPX connected to a fifth data line DL5 in a fifth pixel column PC5, and blue pixels BPX connected to a sixth data line DL6 in a sixth pixel column PC6.

In other embodiments, as illustrated in FIG. 5, a display panel 100b may have an RGBG pixel arrangement structure in which red pixels RPX, green pixels GPX, blue pixels BPX and green pixels GPX are repeatedly arranged along a pixel row direction. In the display panel 100b, one red pixel RPX or one blue pixel BPX and one green pixel GPX may form one unit pixel or one pixel group. For example, one red pixel RPX and one green pixel GPX may form a first unit pixel UPX1, and one blue pixel BPX and one green pixel GPX may form a second unit pixel UPX2. Further, for example, red pixels RPX and blue pixels BPX connected to a first data line DL1 may be repeatedly arranged in a first pixel column PC1, green pixels GPX connected to a second data line DL2 may be repeatedly arranged in a second pixel column PC2, blue pixels BPX and red pixels RPX connected to a third data line DL3 may be repeatedly arranged in a third pixel column PC3, green pixels GPX connected to a fourth data line DL4 may be repeatedly arranged in a fourth pixel column PC4, red pixels RPX and blue pixels BPX connected to a fifth data line DL5 may be repeatedly arranged in a fifth pixel column PC5, green pixels GPX connected to a sixth data line DL6 may be repeatedly arranged in a sixth pixel column PC6, blue pixels BPX and red pixels RPX connected to a seventh data line DL7 may be repeatedly arranged in a seventh pixel column PC7, and green pixels GPX connected to an eighth data line DL8 may be repeatedly arranged in an eighth pixel column PC8. Further, for example, a red pixel RPX, a green pixel GPX, a blue pixel BPX and a green pixel GPX may be repeatedly arranged in each of odd-numbered pixel rows PR1 and PR3, and a blue pixel BPX, a green pixel GPX, a red pixel RPX and a green pixel GPX may be repeatedly arranged in each of even-numbered pixel rows PR2 and PR4.

Although FIG. 5 illustrates an embodiment in which the display panel 100a has an RGB stripe structure, and FIG. 6 illustrates an embodiment in which the display panel 100b has an RGBG pixel arrangement structure, the display panel 100 according to embodiments is not limited to the embodiments of FIGS. 5 and 6.

The lighting test circuit 120 may perform a lighting test that detects a defect in the display panel 100 by allowing the pixels PX to emit light by providing the emission data voltage VEM to the pixels PX through the data lines DL in response to a lighting test signal SLT. In some embodiments, the emission data voltage VEM may be, but is not limited to, a data voltage corresponding to a maximum gray level (e.g., a 255-gray level). In some embodiments, the lighting test may be performed on the display panel 100 in a cell state before the display panel 100 is connected to the data driver 190. In other embodiments, the lighting test may be further performed on the display panel 100 in a module state after the display panel 100 is connected to the data driver 190. Further, the lighting test circuit 120 and the pattern test circuit 160 may be used to perform the pattern test on the display panel 100 in a cell state by allowing the pixels PX to display a pattern image (e.g., a predetermined pattern image). In some embodiments, the lighting test circuit 120 may include an emission data voltage line that transfers the emission data voltage VEM, and multiple lighting test transistors that connect the emission data voltage line to the data lines DL in response to the lighting test signal SLT.

For example, as illustrated in FIG. 4, in an embodiment that the display panel 100a has a RGB stripe structure, a lighting test circuit 120a may include a red emission data voltage line VEML_R that transfers a red emission data voltage VEM_R to the red pixels RPX, a green emission data voltage line VEML_G that transfers a green emission data voltage VEM_G to the green pixels GPX, a blue emission data voltage line VEML_B that transfers a blue emission data voltage VEM_B to the blue pixels BPX, first lighting test transistors LTT1 that connects the red emission data voltage line VEML_R to the first and fourth data lines DL1 and DL4 arranged in the first and fourth pixel columns PC1 and PC4 in response to the lighting test signal SLT, second lighting test transistors LTT2 that connects the green emission data voltage line VEML_G to the second and fifth data lines DL2 and DL5 arranged in the second and fifth pixel columns PC2 and PC5 in response to the lighting test signal SLT, and third lighting test transistors LTT3 that connects the blue emission data voltage line VEML_B to the third and sixth data lines DL3 and DL6 arranged in the third and sixth pixel columns PC3 and PC6 in response to the lighting test signal SLT. To perform the lighting test or the pattern test, the lighting test circuit 120a may receive the lighting test signal SLT within a horizontal time allocated to each pixel row, the first lighting test transistors LTT1 may provide the red emission data voltage VEM_R to the red pixels RPX through the first and fourth data lines DL1 and DL4 in response to the lighting test signal SLT, the second lighting test transistors LTT2 may provide the green emission data voltage VEM_G to the green pixels GPX through the second and fifth data lines DL2 and DL5 in response to the lighting test signal SLT, and the third lighting test transistors LTT3 may provide the blue emission data voltage VEM_B to the blue pixels BPX through the third and sixth data lines DL3 and DL6 in response to the lighting test signal SLT. Thus, the red pixels RPX may emit light based on the red emission data voltage VEM_R, the green pixels GPX may emit light based on the green emission data voltage VEM_G, and the blue pixels BPX may emit light based on the blue emission data voltage VEM_B.

In another embodiment, as illustrated in FIG. 5, in an embodiment that the display panel 100b has a RGBG pixel arrangement structure, a lighting test circuit 120b may include the red emission data voltage line VEML_R that transfers the red emission data voltage VEM_R to the red pixels RPX, the green emission data voltage line VEML_G that transfers the green emission data voltage VEM_G to the green pixels GPX, the blue emission data voltage line VEML_B that transfers the blue emission data voltage VEM_B to the blue pixels BPX, first-first lighting test transistors LTT1-1 that connect the red emission data voltage line VEML_R to the first and fifth data lines DL1 and DL5 arranged in the first and fifth pixel columns PC1 and PC5 in response to a first lighting test signal SLT1, and first-second lighting test transistors LTT1-2 that connect the blue emission data voltage line VEML_B to the first and fifth data lines DL1 and DL5 arranged in the first and fifth columns PC1 and PC5 in response to a second lighting test signal SLT2, second lighting test transistors LTT2 that connect the green emission data voltage line VEML_G to the second and sixth data lines DL2 and DL6 arranged in the second and sixth pixel columns PC2 and PC6 in response to a third lighting test signal SLT3, third-first lighting test transistors LTT3-1 that connect the blue emission data voltage line VEML_B to the third and seventh data lines DL3 and DL7 arranged in the third and seventh pixel columns PC3 and PC7 in response to the first lighting test signal SLT1, third-second lighting test transistors LTT3-2 that connect the red emission data voltage line VEML_R to the third and seventh data lines DL3 and DL7 arranged in the third and seventh pixel columns PC3 and PC7 in response to the second lighting test signal SLT2, and fourth lighting test transistors LTT4 that connect the green emission data voltage line VEML_G to the fourth and eighth data lines DL4 and DL8 arranged in the fourth and eighth pixel columns PC4 and PC8 in response to the third lighting test signal SLT3. To perform the lighting test or the pattern test, the lighting test circuit 120b may receive the first lighting test signal SLT1 and the third lighting test signal SLT3 within a horizontal time allocated to each odd-numbered pixel row PR1 and PR3, the first-first lighting test transistors LTT1-1 may provide the red emission data voltage VEM_R to the red pixels RPX arranged in the odd-numbered pixel rows PR1 and PR3 through the first and fifth data lines DL1 and DL5 in response to the first lighting test signal SLT1, the third-first lighting test transistors LTT3-1 may provide the blue emission data voltage VEM_B to the blue pixels BPX arranged in the odd-numbered pixel rows PR1 and PR3 through the third and seventh data lines DL3 and DL7 in response to the first lighting test signal SLT1, and the second and fourth lighting test transistors LTT2 and LTT4 may provide the green emission data voltage VEM_G to the green pixels GPX through the second, fourth, sixth and eighth data lines DL2, DL4, DL6 and DL8 in response to the third lighting test signal SLT3. Further, the lighting test circuit 120b may receive the second lighting test signal SLT2 and the third lighting test signal SLT3 within a horizontal time allocated to each even-numbered pixel row PR2 and PR4, the first-second lighting test transistors LTT1-2 may provide the blue emission data voltage VEM_B to the blue pixels BPX arranged in the even-numbered pixel rows PR2 and PR4 through the first and fifth data lines DL1 and DL5 in response to the second lighting test signal SLT2, the third-second lighting test transistors LTT3-2 may provide the red emission data voltage VEM_R to the red pixels RPX arranged in the even-numbered pixel rows PR2 and PR4 through the third and seventh data lines DL3 and DL7 in response to the second lighting test signal SLT2, and the second and fourth lighting test transistors LTT2 and LTT4 provide the green emission data voltage VEM_G to the green pixels GPX through the second, fourth, sixth and eighth data lines DL2, DL4, DL6 and DL8 in response to the third lighting test signal SLT3. Thus, the red pixels RPX may emit light based on the red emission data voltage VEM_R, the green pixels GPX may emit light based on the green emission data voltage VEM_G, and the blue pixels BPX may emit light based on the blue emission data voltage VEM_B.

The open-short test circuit 140 may perform the open-short test that detects an open-circuit defect of each data line DL and a short-circuit defect between the data lines DL by alternately providing a first open-short test voltage VOST1 and a second open-short test voltage VOST2 to the data lines DL in response to an open-short test signal SOST. In some embodiments, the open-short test may be performed on the display panel 100 in a cell state before the display panel 100 is connected to the data driver 190. In other embodiments, the open-short test may be further performed on the display panel 100 in a module state after the display panel 100 is connected to the data driver 190. In some embodiments, the first open-short test voltage VOST1 may be, but is not limited to, a black data voltage (e.g., a data voltage corresponding to a 0-gray level), and the second open-short test voltage VOST2 may be, but is not limited to, a white data voltage (e.g., a data voltage corresponding to a 255-gray level). The first open-short test voltage VOST1 may correspond to the non-emission data voltage VNEM, and the second open-short test voltage VOST2 may correspond to the emission data voltage VEM. In some embodiments, the pattern test circuit 160 may receive the first open-short test voltage VOST1 from the open-short test circuit 140 as the non-emission data voltage VNEM. In other embodiments, the first open-short test voltage VOST1 may be, but is not limited to, a white data voltage, and the second open-short test voltage VOST2 may be, but is not limited to, a black data voltage. In some embodiments, the open-short test circuit 140 may provide one of the first and second open-short test voltages VOST1 and VOST2 to each unit pixel UPX such that the first and second open-short test voltages VOST1 and VOST2 are alternately provided to respective unit pixels along the pixel row direction.

For example, as illustrated in FIG. 4, in an embodiment that the display panel 100a has a RGB stripe structure, the open-short test circuit 140a may include a first open-short test voltage line VOSTL1 which transfers the first open-short test voltage VOST1, a second open-short test voltage line VOSTL2 which transfers the second open-short test voltage VOST2, first open-short test transistors OSTT1 which connect the first open-short test voltage line VOSTL1 to the first, second and third data lines DL1, DL2 and DL3 arranged in the first, second and third pixel columns PC1, PC2 and PC3 in response to the open-short test signal SOST, and second open-short test transistors OSTT2 which connect the second open-short test voltage line VOSTL2 to the fourth, fifth and sixth data lines DL4, DL5 and DL6 arranged in the fourth, fifth and sixth pixel columns PC4, PC5 and PC6 in response to the open-short test signal SOST. Thus, when performing the open-short test, the open-short test circuit 140a may alternately provide the first open-short test voltage VOST1 and the second open-short test voltage VOST2 to each group of three data lines. In some embodiments, the first open-short test voltage VOST1 of the first open-short test voltage line VOSTL1 may be provided to the pattern test circuit 160 as the non-emission data voltage VNEM.

In another embodiment, as illustrated in FIG. 5, in an embodiment that the display panel 100b has a RGBG pixel arrangement structure, the open-short test circuit 140b may include the first open-short test voltage line VOSTL1 which transfers the first open-short test voltage VOST1, the second open-short test voltage line VOSTL2 which transfers the second open-short test voltage VOST2, the first open-short test transistors OSTT1 which connect the first open-short test voltage line VOSTL1 to the first, second, fifth and sixth data lines DL1, DL2, DL5 and DL6 arranged in the first, second, fifth and sixth pixel columns PC1, PC2, PC5 and PC6 in response to the open-short test signal SOST, and the second open-short test transistors OSTT2 which connect the second open-short test voltage line VOSTL2 to the third, fourth, seventh and eighth data lines DL3, DL4, DL7 and DL8 arranged in the third, fourth, seventh and eighth pixel columns PC3, PC4, PC7 and PC8 in response to the open-short test signal SOST. Thus, when performing the open-short test, the open-short test circuit 140b may alternately provide the first open-short test voltage VOST1 and the second open-short test voltage VOST2 to each group of two data lines. In some embodiments, the first open-short test voltage VOST1 of the first open-short test voltage line VOSTL1 may be provided to the pattern test circuit 160 as the non-emission data voltage VNEM.

The pattern test circuit 160 may provide the non-emission data voltage VNEM to a portion of the pixels PX through the data lines DL in response to the first pattern test signal SPT1 and/or the second pattern test signal SPT2. In some embodiments, the non-emission data voltage VNEM may be, but is not limited to, a data voltage corresponding to a minimum gray level (e.g., a 0-gray level). Further, in some embodiments, the pattern test circuit 160 may receive, but not limited to, the first open-short test voltage VOST1 from the open-short test circuit 140 as the non-emission data voltage VNEM.

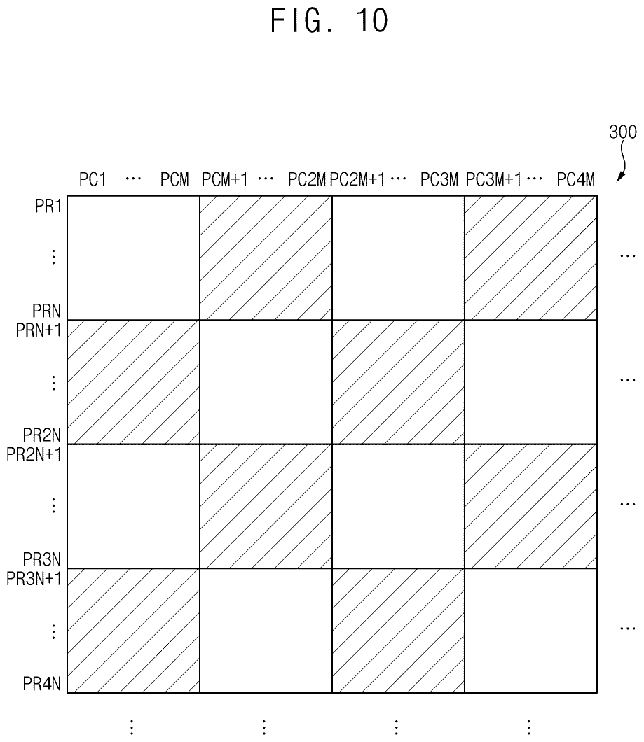

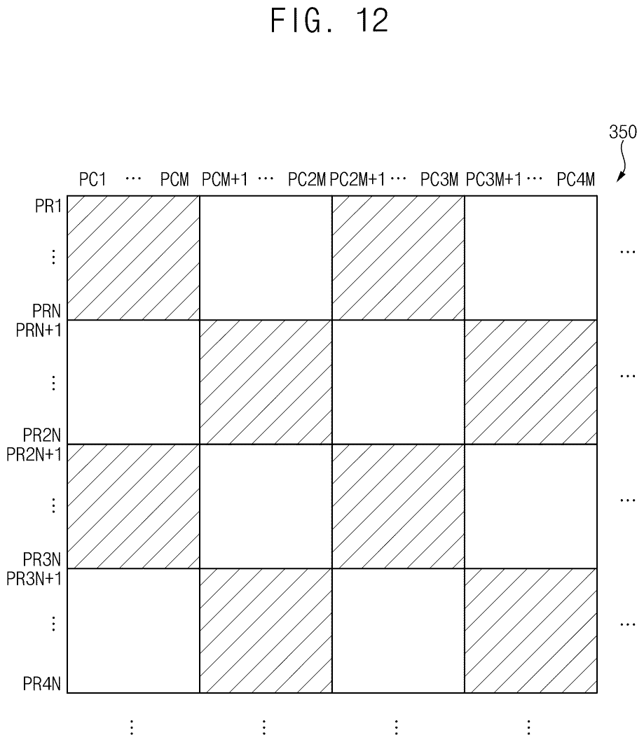

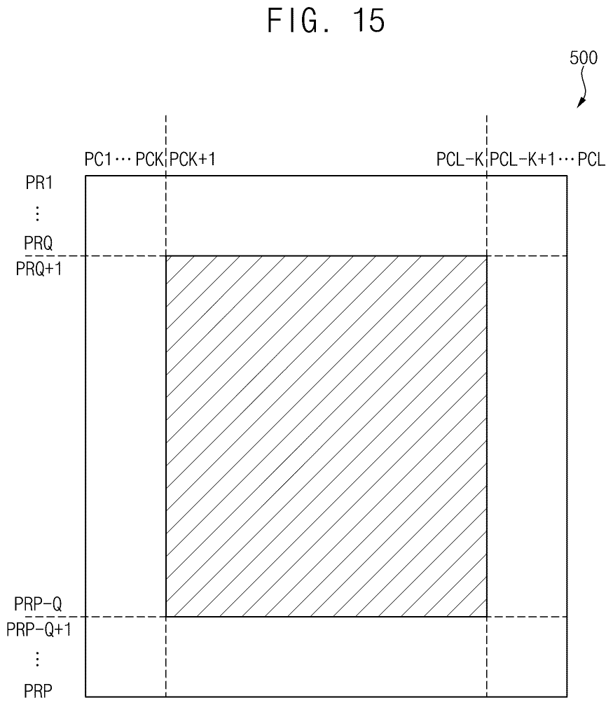

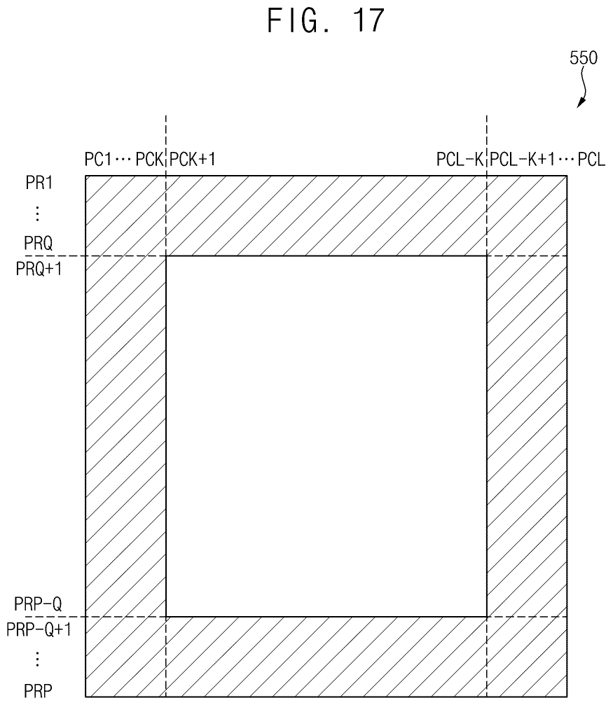

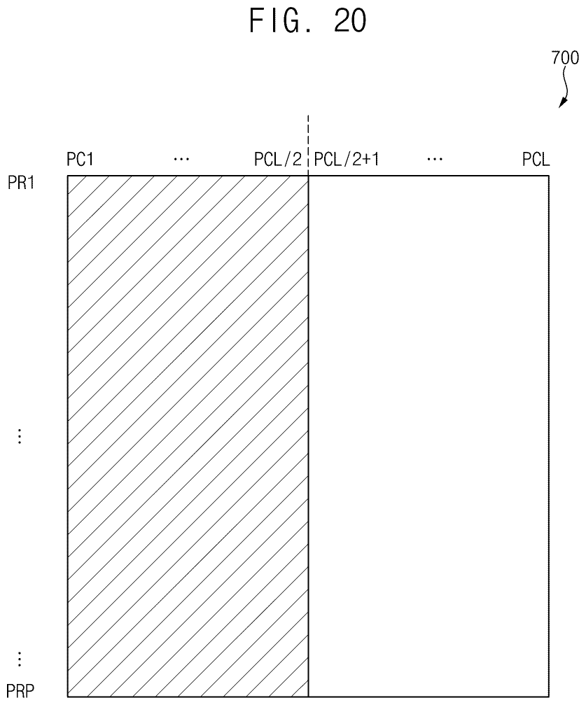

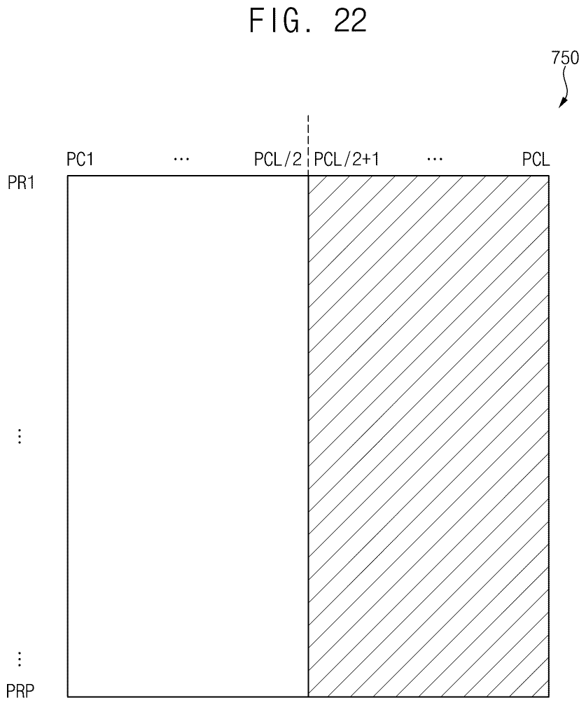

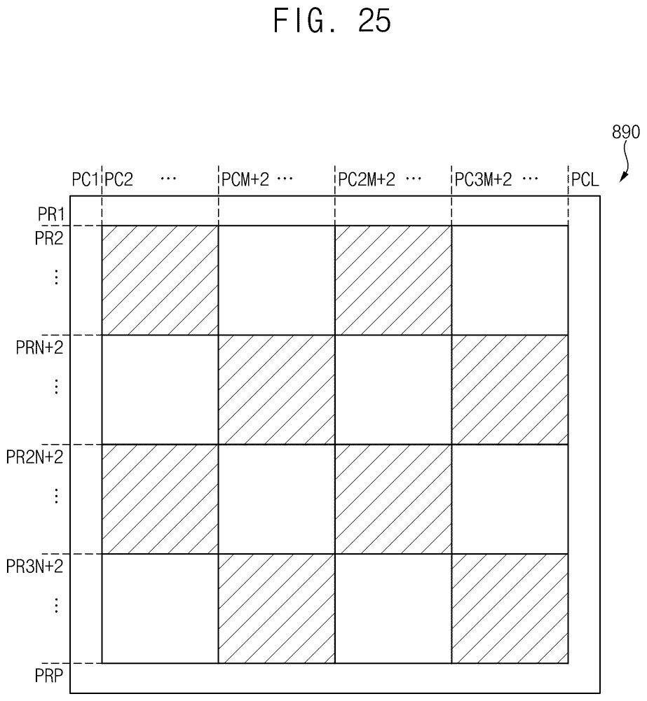

The lighting test circuit 120 and the pattern test circuit 160 may be used to perform the pattern test in a cell state before the display panel 100 is connected to the data driver 190. To perform the pattern test, an initial luminance of the display panel 100 may be measured, and the pixels PX may display a pattern image for a certain time period (e.g., about ten minutes to about one hour). According to embodiments, the pattern image may be, but is not limited to, a chess pattern image illustrated in FIGS. 10 and 12, an outer line image illustrated in FIG. 15, a central region image illustrated in FIG. 17, a right region image illustrated in FIG. 20, a left region image illustrated in FIG. 22, or a combination of the chess pattern image and the outer line image illustrated in FIG. 25. In order for the pixels PX to display a pattern image, the lighting test circuit 120 may provide the emission data voltage VEM to the pixels PX, and the pattern test circuit 160 may provide the non-emission data voltage VNEM to a portion of the pixels PX after the emission data voltage VEM is provided to the pixels PX. For example, the lighting test circuit 120 may provide the emission data voltage VEM to all the pixels PX arranged in a pixel row in a first period within a horizontal time allocated to the pixel row, and the pattern test circuit 160 may provide the non-emission data voltage VNEM to a portion of the pixels PX arranged in the pixel row in a second period after the first period within the horizontal time. Accordingly, a portion of the pixels PX to which the non-emission data voltage VNEM is provided may not emit light, and the remainder of the pixels PX to which the non-emission data voltage VNEM is not provided may emit light, and thus the pixels PX may display a pattern image. After the pixels PX displays the pattern image, a final luminance of the display panel 100 may be measured. The pattern test may detect whether the display panel 100 is defective based on a luminance difference between the initial luminance and the final luminance.

In some embodiments, the pattern test circuit 160 may include a non-emission data voltage line which transfers the non-emission data voltage VNEM, multiple first pattern test transistors which connects the non-emission data voltage line to a portion of the data lines DL in response to a first pattern test signal SPT1, and multiple second pattern test transistors which connects the non-emission data voltage line to the remainder of the data lines DL in response to a second pattern test signal SPT2. For example, as illustrated in FIG. 6, the non-emission data voltage line VNEML may receive the first open-short test voltage VOST1 of the open-short test circuit 140 as the non-emission data voltage VNEM. The first pattern test transistors PTT1 may connect the non-emission data voltage line VNEML to first through M-th data lines DL1 through DLM arranged in first through M-th pixel columns PC1 through PCM in response to the first pattern test signal SPT1, where M may be an integer greater than 0. Further, the second pattern test transistors PTT2 may connect the non-emission data voltage line VNEML to (M+1)-th through 2M-th data lines DLM+1 through DL2M arranged in (M+1)-th through 2M-th pixel columns PCM+1 through PC2M in response to the second pattern test signal SPT2.

The lighting test circuit 120 may receive the lighting test signal SLT in a first period within each horizontal time, and the pattern test circuit 160 may receive one of the first pattern test signal SPT1 and the second pattern test signal SPT2 in a second period after the first period within the horizontal time. For example, as illustrated in FIGS. 6 and 7, a frame period FP may include first through N-th horizontal times HT1 through HTN allocated to first through N-th pixel rows PR1 through PRN of the display panel 100, where N may be an integer greater than 0, and (N+1)-th through 2N-th horizontal times HTN+1 through HT2N allocated to (N+1)-th through 2N-th pixel rows PRN+1 through PR2N of the display panel 100. The gate driver 180 may sequentially apply first through N-th write signals GW1 through GWN to the first through N-th pixel rows PR1 through PRN in the first through N-th horizontal times HT1 through HTN, and may sequentially apply (N+1)-th through 2N-th write signals GWN+1 through GW2N to the (N+1)-th through 2N-th pixel rows PRN+1 through PR2N in the (N+1)-th through 2N-th horizontal times HTN+1 through HT2N. The lighting test circuit 120 may receive the lighting test signal SLT having an on-level (e.g., a low level) in the first period P1 within each of the first through 2N-th horizontal times HT1 through HT2N, and may sequentially provide the emission data voltage VEM to all the pixels PX in the first through 2N-th pixel rows PR1 through PR2N on a row-by-row basis.

In the second period P2 after the first period P1 within each of the first through N-th horizontal periods HT1 through HTN, the pattern test circuit 160 may not receive the first pattern test signal SPT1 having an on-level (e.g., a low level), but may receive the second pattern test signal SPT2 having an on-level. Thus, in the first through N-th horizontal periods HT1 through HTN, the second pattern test transistors PTT2 of the pattern test circuit 160 may provide the non-emission data voltage VNEM to the pixels PX arranged in the (M+1)-th through 2M-th pixel columns PCM+1 through PC2M in response to the second pattern test signal SPT2, and the pixels PX arranged in the first through M-th pixel columns PC1 through PCM may not receive the non-emission data voltage VNEM. Accordingly, a first display region DR1 including the pixels PX arranged in the first through N-th pixel rows PR1 through PRN and the first through N-th pixel columns PC1 through PCM may emit light, and a second display region DR2 including the pixels PX arranged in the first through N-th pixel rows PR1 through PRN and the (M+1)-th through 2M-th pixel columns PCM+1 through PC2M may not emit light.

In the second period P2 after the first period P1 within each of the (N+1)-th through 2N-th horizontal times HTN+1 through HT2N, the pattern test circuit 160 may not receive the second pattern test signal SPT2 having an on-level, but may receive the first pattern test signal SPT1 having an on-level. Thus, in the (N+1)-th through 2N-th horizontal times HTN+1 through HT2N, the first pattern test transistors PTT1 of the pattern test circuit 160 may provide the non-emission data voltage VNEM to the pixels PX arranged in the first through M-th pixel columns PC1 through PCM in response to the first pattern test signal SPT1, and the pixels PX arranged in the (M+1)-th through 2M-th pixel columns PCM+1 through PC2M may not receive the non-emission data voltage VNEM. Accordingly, a third display region DR3 including the pixels PX arranged in the (N+1)-th through 2N-th pixel rows PRN+1 through PR2N and the first through M-th pixel columns PC1 through PCM may not emit light, and a fourth display region DR4 including the pixels PX arranged in the (N+1)-th through 2N-th pixel rows PRN+1 through PR2N and the (M+1)-th through 2M-th pixel columns PCM+1 through PC2M may emit light. In this manner, the display panel 100 according to embodiments may display the pattern image in a cell state before the display panel 100 is connected to the data driver 190, and the pattern test may be performed on the display panel 100 in a cell state.

In a conventional display device, a data driver is required for a display panel to display a pattern image. Thus, in the conventional display device, the pattern test may be performed in a module state after the data driver is connected to the display panel. However, in the display panel 100 according to embodiments, the lighting test circuit 120 may provide the emission data voltage VEM to the pixels PX, and the pattern test circuit 160 may provide the non-emission data voltage VNEM to the portion of the pixels PX. Accordingly, the display panel 100 according to embodiments may display a pattern image in a cell state, and thus the pattern test may be performed on the display panel 100 in a cell state. Accordingly, since the pattern test may be performed at an early stage in a manufacturing process of a display device, defects and failures of the display panel 100 may be rapidly and accurately detected.

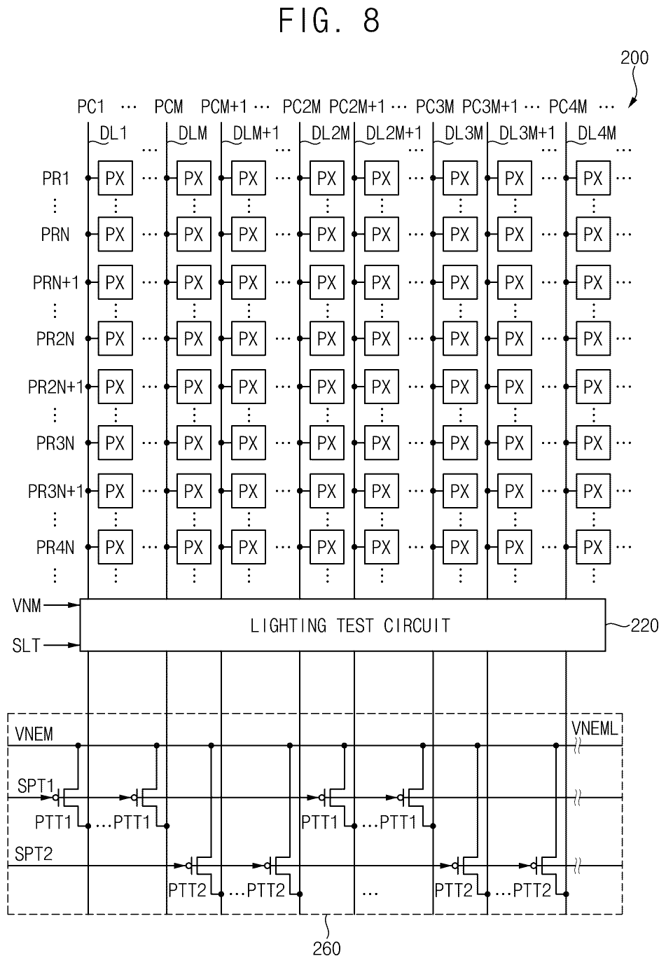

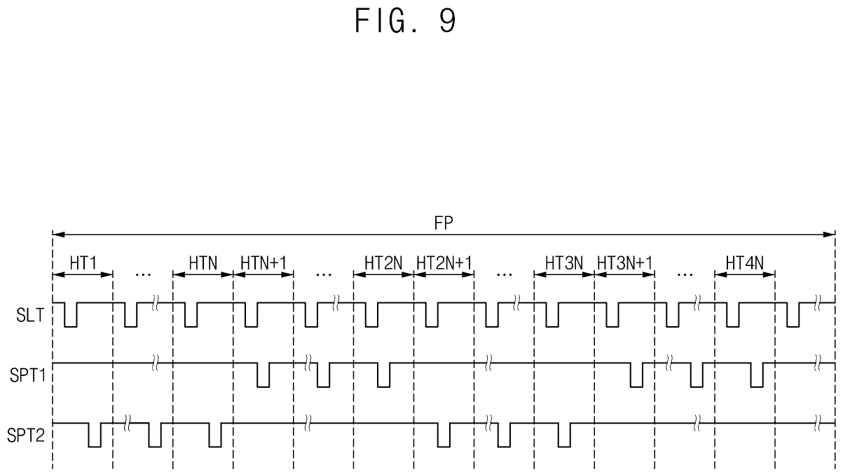

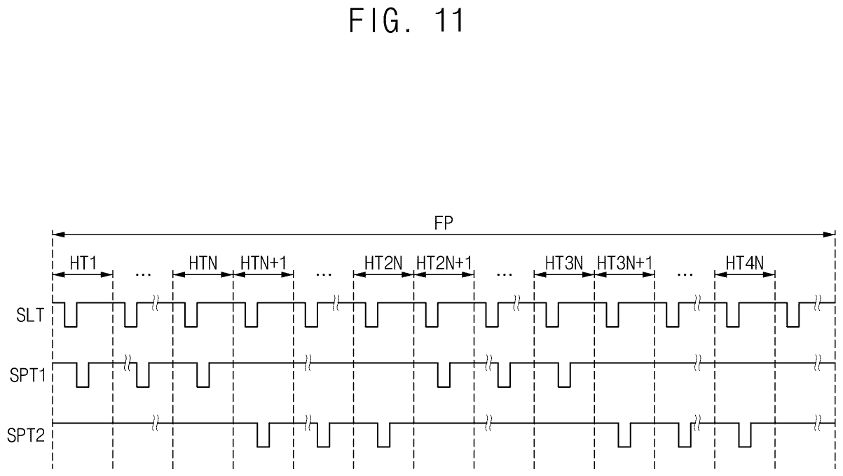

FIG. 8 is a schematic diagram illustrating a display panel according to embodiments, FIG. 9 is a schematic timing diagram for describing an operation of a display panel according to embodiments, FIG. 10 is a schematic diagram illustrating a pattern image displayed by a display panel according to embodiments, FIG. 11 is a schematic timing diagram for describing an operation of a display panel according to embodiments, and FIG. 12 is a schematic diagram illustrating a pattern image displayed by a display panel according to embodiments.

Referring to FIG. 8, a display panel 200 according to embodiments may include multiple data lines DL1 through DL4M, multiple pixels PX, a lighting test circuit 220, and a pattern test circuit 260. In some embodiments, although it is not illustrated in FIG. 8, the display panel 200 may further include an open-short test circuit, a crack detection circuit, a one-sheet test circuit, etc.

The data lines DL1 through DL4M may include first through M-th data lines DL1 through DLM arranged in first through M-th pixel columns PC1 through PCM, (M+1)-th through 2M-th data lines DLM+1 through DL2M arranged in (M+1)-th through 2M-th pixel columns PCM+1 through PC2M, (2M+1)-th through 3M-th data lines DL2M+1 through DL3M arranged in (2M+1)-th through 3M-th pixel columns PC2M+1 through PC3M, and (3M+1)-th through 4M-th data lines DL3M+1 through DL4M arranged in (3M+1)-th through 4M-th pixel columns PC3M+1 through PC4M, where M may be an integer greater than 0.

The pattern test circuit 260 may include a non-emission data voltage line VNEML which transfers a non-emission data voltage VNEM, multiple first pattern test transistors PTT1 which connects the non-emission data voltage line VNEML to the first through M-th data lines DL1 through DLM and the (2M+1)-th through 3M-th data lines DL2M+1 through DL3M in response to a first pattern test signal SPT1, and multiple second pattern test transistors PTT2 which connects the non-emission data voltage line VNEML to the (M+1)-th through 2M-th data lines DLM+1 through DL2M and the (3M+1)-th through 4M-th data lines DL3M+1 through DL4M in response to a second pattern test signal SPT2.

As illustrated in FIGS. 9 and 11, the lighting test circuit 220 may receive a lighting test signal SLT having an on-level (e.g., a low level) in a first period within each of first through N-th horizontal times HT1 through HTN allocated to first through N-th pixel rows PR1 through PRN, (N+1)-th through 2N-th horizontal times HTN+1 through HT2N allocated to (N+1)-th through 2N-th pixel rows PRN+1 through PR2N, (2N+1)-th through 3N-th horizontal times HT2N+1 through HT3N allocated to (2N+1)-th through 3N-th pixel rows PR2N+1 through PR3N, and (3N+1)-th through 4N-th horizontal times HT3N+1 through HT4N allocated to (3N+1)-th through 4N-th pixel rows PR3N+1 through PR4N, where N is an integer greater than 0. Thus, the lighting test circuit 220 may provide an emission data voltage VEM to all the pixels PX arranged in the first through 4N-th pixel rows PR1 through PR4N in the first through 4N-th horizontal times HT1 through HT4N.

In some embodiments, as illustrated in FIG. 9, in a second period after the first period within each of the first through N-th horizontal times HT1 through HTN and the (2N+1)-th through 3N-th horizontal times HT2N+1 through HT3N, the pattern test circuit 260 may receive the second pattern test signal SPT2 having an on-level, and may not receive the first pattern test signal SPT1 having an on-level. Thus, the pattern test circuit 260 may provide the non-emission data voltage VNEM only to the pixels PX arranged in the (M+1)-th through 2M-th pixel columns PCM+1 through PC2M and the (3M+1)-th through 4M-th pixel columns PC3M+1 through PC4M among the pixels PX arranged in the first through N-th pixel rows PR1 through PRN and the (2N+1)-th through 3N-th pixel rows PR2N+1 through PR3N. Further, in a second period after the first period within each of the (N+1)-th through 2N-th horizontal times HTN+1 through HT2N and the (3N+1)-th through 4N-th horizontal times HT3N+1 through HT4N, the pattern test circuit 260 may receive the first pattern test signal SPT1 having an on-level, and may not receive the second pattern test signal SPT2 having the on-level. Thus, the pattern test circuit 260 may provide the non-emission data voltage VNEM only to the pixels PX arranged in the first through M-th pixel columns PC1 through PCM and the (2M+1)-th through 3M-th pixel columns PC2M+1 through PC3M among the pixels PX arranged in the (N+1)-th through 2N-th pixel rows PRN+1 through PR2N and the (3N+1)-th through 4N-th pixel rows PR3N+1 through PR4N. Accordingly, the display panel 200 may display a chess pattern image 300 illustrated in FIG. 10 in a cell state in response to the lighting test signal SLT, the first pattern test signal SPT1, and the second pattern test signal SPT2 illustrated in FIG. 9.

In other embodiments, as illustrated in FIG. 11, in the second period after the first period within each of the first through N-th horizontal times HT1 through HTN and the (2N+1)-th through 3N-th horizontal times HT2N+1 through HT3N, the pattern test circuit 260 may receive the first pattern test signal SPT1 having an on-level, and may not receive the second pattern test signal SPT2 having an on-level. Thus, the pattern test circuit 260 may provide the non-emission data voltage VNEM only to the pixels PX arranged in the first through M-th pixel columns PC1 through PCM and the (2M+1)-th through 3M-th pixel columns PC2M+1 through PC3M among the pixels PX arranged in the first through N-th pixel rows PR1 through PRN and the (2N+1)-th through 3N-th pixel rows PR2N+1 through PR3N. Further, in the second period after the first period within each of the (N+1)-th through 2N-th horizontal times HTN+1 through HT2N and the (3N+1)-th through 4N-th horizontal times HT3N+1 through HT4N, the pattern test circuit 260 may receive the second pattern test signal SPT2 having an on-level, and may not receive the first pattern test signal SPT1 having an on-level. Thus, the pattern test circuit 260 may provide the non-emission data voltage VNEM only to the pixels PX arranged in the (M+1)-th through 2M-th pixel columns PCM+1 through PC2M and the (3M+1)-th through 4M-th pixel columns PC3M+1 through PC4M among the pixels PX arranged in the (N+1)-th through 2N-th pixel rows PRN+1 through PR2N and the (3N+1)-th through 4N-th pixel rows PR3N+1 through PR4N. Accordingly, the display panel 200 may display a chess pattern image 350 illustrated in FIG. 12 in the cell state in response to the lighting test signal SLT, the first pattern test signal SPT1, and the second pattern test signal SPT2 illustrated in FIG. 11.

As described above, in the display panel 200 according to embodiments, the lighting test circuit 220 may provide the emission data voltage VEM to the pixels PX, and the pattern test circuit 260 may provide the non-emission data voltage VNEM to a portion of the pixels PX. Accordingly, the display panel 200 according to embodiments may display a chess pattern image 300 and 350 in a cell state, and thus a pattern test may be performed on the display panel 200 in a cell state.

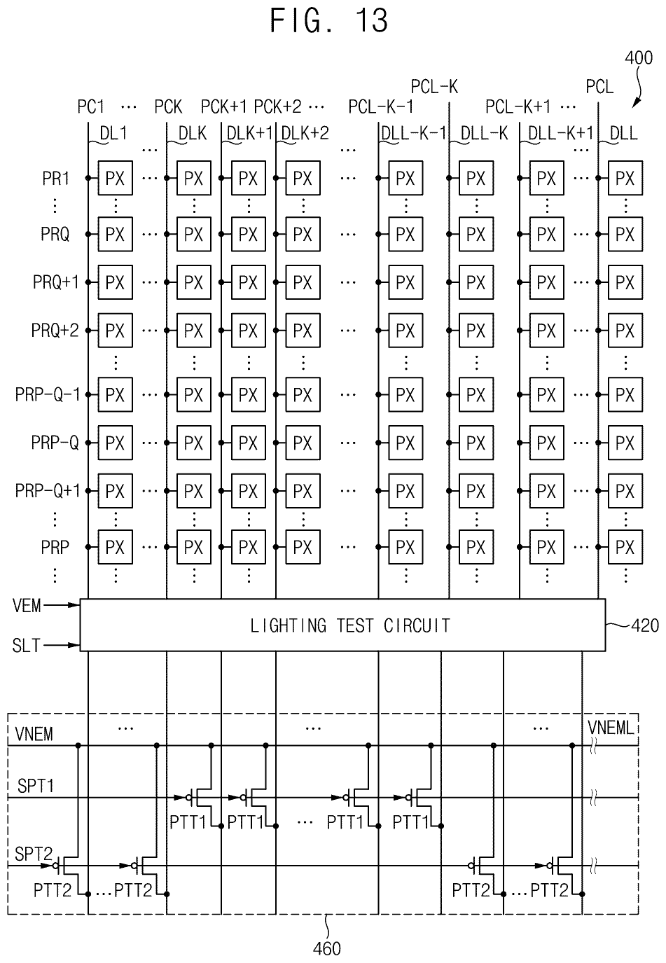

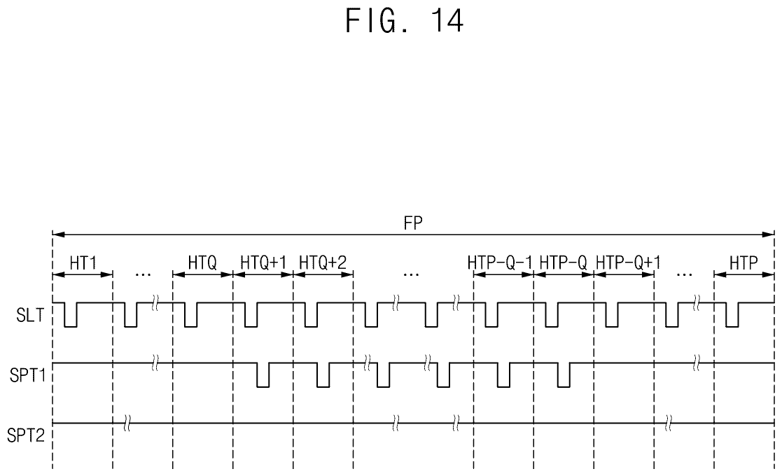

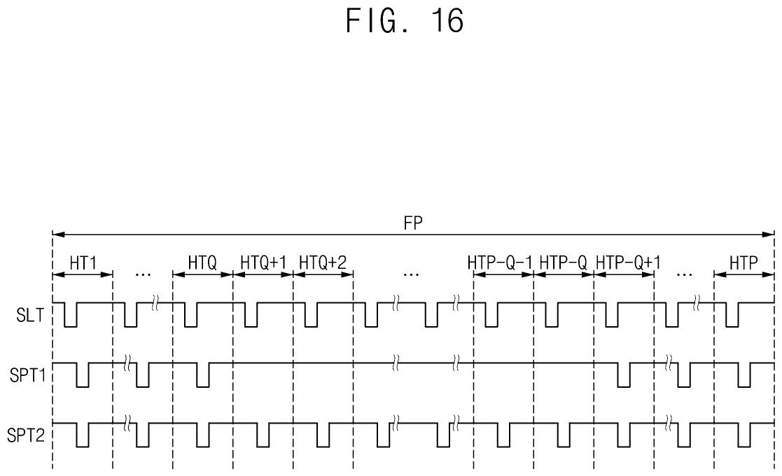

FIG. 13 is a schematic diagram illustrating a display panel according to embodiments, FIG. 14 is a schematic timing diagram for describing an operation of a display panel according to embodiments, FIG. 15 is a schematic diagram illustrating a pattern image displayed by a display panel according to embodiments, FIG. 16 is a schematic timing diagram for describing an operation of a display panel according to embodiments, and FIG. 17 is a schematic diagram illustrating of a pattern image displayed by a display panel according to embodiments.

Referring to FIG. 13, a display panel 400 according to embodiments may include first through L-th data lines DL1 through DLL arranged in first through L-th pixel columns PC1 through PCL, where L may be an integer greater than 0, multiple pixels PX, a lighting test circuit 420 and a pattern test circuit 460. In some embodiments, although it is not illustrated in FIG. 13, the display panel 400 may further include an open-short test circuit, a crack detection circuit, a one-sheet test circuit, etc.

The pattern test circuit 460 may include a non-emission data voltage line VNEML which transfers a non-emission data voltage VNEM, multiple first pattern test transistors PTT1 which connects the non-emission data voltage line VNEML to (K+1)-th through (L−K)-th data lines DLK+1, DLK+2, . . . , DLL−K−1 and DLL-K arranged in (K+1)-th through (L−K)-th pixel columns PCK+1, PCK+2, . . . , PCL−K−1 and PCL-K in response to a first pattern test signal SPT1, and multiple second pattern test transistors PTT2 connecting the non-emission data voltage line VNEML to the first through K-th data lines DL1 through DLK arranged in the first through K-th pixel columns PC1 through PCK and (L−K+1)-th through L-th data lines DLL−K+1 through DLL arranged in (L−K+1)-th through L-th pixel columns PCL−K+1 through PCL in response to a second pattern test signal SPT2, where K may be an integer greater than 0 and less than L/2.

The display panel 400 may include first through P-th pixel rows PR1, . . . , PRQ, PRQ+1, PRQ+2, . . . , PRP−Q−1, PRP−Q, PRP−Q+1, . . . , PRP, where P may be an integer greater than 0. As illustrated in FIGS. 14 and 16, the lighting test circuit 420 may receive a lighting test signal SLT having an on-level (e.g., a low level) in a first period within each of first through P-th horizontal times HT1, . . . , HTQ, HTQ+1, HTQ+2, . . . , HTP−Q−1, HTP-Q, HTP−Q+1, . . . , HTP allocated to the first through P-th pixel rows PR1 through PRP. Thus, the lighting test circuit 420 may provide an emission data voltage VEM to all the pixels PX.

In some embodiments, as illustrated in FIG. 14, in each of the first through Q-th horizontal times HT1, . . . , HTQ and (P−Q+1)-th through P-th horizontal times HTP−Q+1, . . . , HTP among the first through P-th horizontal times HT1 through HTP, where Q is an integer greater than 0 and less than P/2, the pattern test circuit 460 may not receive any of the first pattern test signal SPT1 and the second pattern test signal SPT2 having an on-level. Thus, the non-emission data voltage VNEM may not be provided to the pixels PX arranged in the first through Q-th pixel rows PR1, . . . , PRQ and (P−Q+1)-th through P-th pixel rows PRP−Q+1, . . . , PRP. Further, in a second period after the first period within each of (Q+1)-th through (P−Q)-th horizontal times HTQ+1, HTQ+2, . . . . , HTP−Q−1 and HTP−Q among the first through P-th horizontal times HT1 through HTP, the pattern test circuit 460 may receive the first pattern test signal SPT1 having an on-level, and may not receive the second pattern test signal SPT2 having an on-level. Thus, the pattern test circuit 460 may provide the non-emission data voltage VNEM only to the pixels PX arranged in the (K+1)-th through (L−K)-th pixel columns PCK+1, PCK+2, . . . , PCL−K−1 and PCL-K among the pixels PX arranged in the (Q+1)-th through (P−Q)-th pixel rows PRQ+1, PRQ+2, . . . , PRP−Q−1 and PRP−Q. Accordingly, the display panel 400 may display an outer line image 500 illustrated in FIG. 15 in a cell state in response to the lighting test signal SLT, the first pattern test signal SPT1, and the second pattern test signal SPT2 illustrated in FIG. 14.

In other embodiments, as illustrated in FIG. 16, in a second period after the first period within each of the first through Q-th horizontal times HT1, . . . , HTQ and the (P−Q+1)-th through P-th horizontal times HTP−Q+1, . . . , HTP, the pattern test circuit 460 may receive both the first pattern test signal SPT1 and the second pattern test signal SPT2 having an on-level. Thus, the non-emission data voltage VNEM may be provided to all the pixels PX arranged in the first through Q-th pixel rows PR1, . . . , PRQ and the (P−Q+1)-th through P-th pixel rows PRP−Q+1, . . . , PRP. Further, in the second period after the first period within each of the (Q+1)-th through (P−Q)-th horizontal times HTQ+1, HTQ+2, . . . , HTP−Q−1 and HTP-Q among the first through P-th horizontal times HT1 through HTP, the pattern test circuit 460 may receive the second pattern test signal SPT2 having an on-level, and may not receive the first pattern test signal SPT1 having an on-level. Thus, the pattern test circuit 460 may provide the non-emission data voltage VNEM only to the pixels PX arranged in the first through K-th pixel columns PC1 through PCK and the (L−K+1)-th through L-th pixel columns PCL−K+1 through PCL among the pixels PX arranged in the (Q+1)-th through (P−Q)-th pixel rows PRQ+1, PRQ+2, . . . , PRP-Q−1 and PRP−Q. Accordingly, the display panel 400 may display a central region image 550 illustrated in FIG. 17 in a cell state in response to the lighting test signal SLT, the first pattern test signal SPT1, and the second pattern test signal SPT2 illustrated in FIG. 16.

As described above, in the display panel 400 according to embodiments, the lighting test circuit 420 may provide the emission data voltage VEM to the pixels PX, and the pattern test circuit 460 may provide the non-emission data voltage VNEM to a portion of the pixels PX. Accordingly, the display panel 400 according to embodiments may display the outer line image 500 or the central region image 550 in a cell state, and thus a pattern test may be performed on the display panel 400 in a cell state.

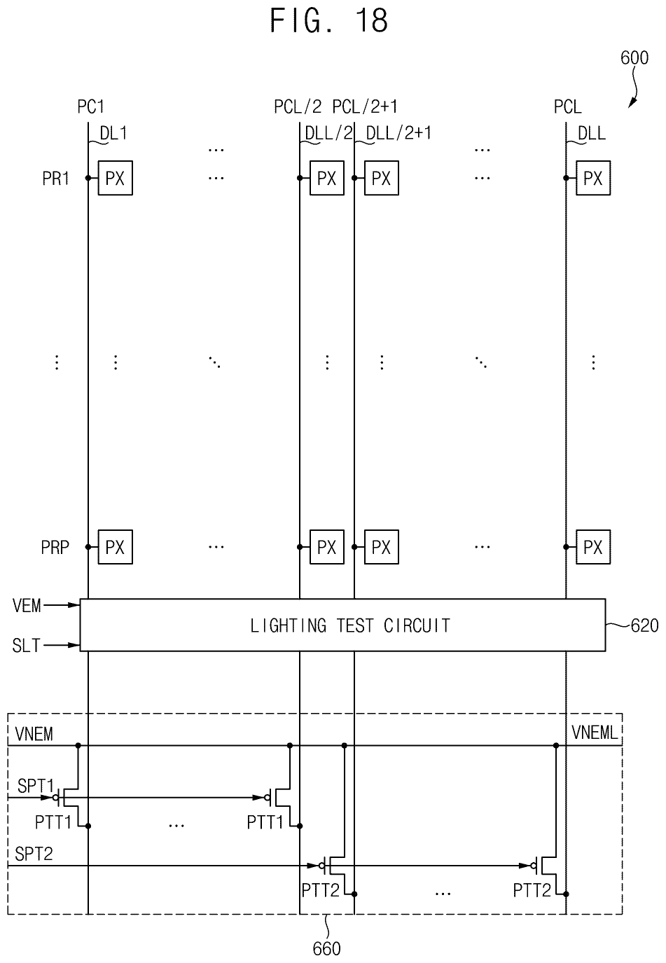

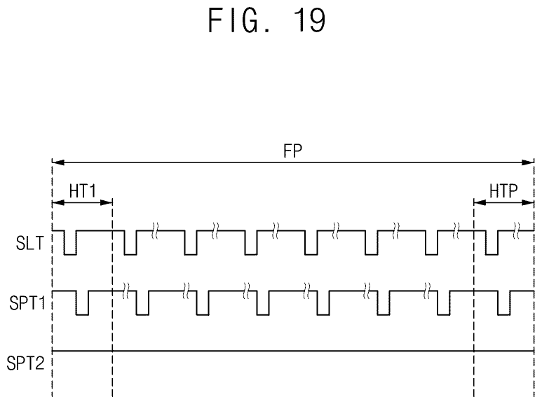

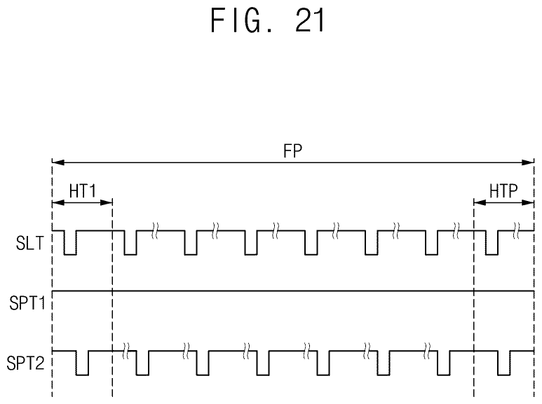

FIG. 18 is a schematic diagram illustrating a display panel according to embodiments, FIG. 19 is a schematic timing diagram for describing an operation of a display panel according to embodiments, FIG. 20 is a schematic diagram illustrating a pattern image displayed by a display panel according to embodiments, FIG. 21 is a schematic timing diagram for describing an operation of a display panel according to embodiments, and FIG. 22 is a schematic diagram illustrating a pattern image displayed by a display panel according to embodiments.

Referring to FIG. 18, a display panel 600 according to embodiments may include first through L-th data lines DL1 through DLL arranged in first through L-th pixel columns PC1 through PCL, multiple pixels PX, a lighting test circuit 620, and a pattern test circuit 660. In some embodiments, although it is not illustrated in FIG. 18, the display panel 600 may further include an open-short test circuit, a crack detection circuit, a one-sheet test circuit, etc.

The pattern test circuit 660 may include a non-emission data voltage line VNEML which transfers a non-emission data voltage VNEM, multiple first pattern test transistors PTT1 which connects the non-emission data voltage line VNEML to the first through (L/2)-th data lines DL1 through DLL/2 arranged in the first through (L/2)-th pixel columns PC1 through PCL/2 in response to a first pattern test signal SPT1, and multiple second pattern test transistors PTT2 which connects the non-emission data voltage line VNEML to (L/2+1)-th through L-th data lines DLL/2+1 through DLL arranged in (L/2+1)-th through L-th pixel columns PCL/2+1 through PCL in response to a second pattern test signal SPT2.

The display panel 600 may include first through P-th pixel rows PR1 through PRP. As illustrated in FIGS. 19 and 21, the lighting test circuit 660 may receive a lighting test signal SLT having an on-level (e.g., a low level) in a first period within each of first through P-th horizontal times HT1 through HTP allocated to the first through P-th pixel rows PR1 through PRP. Thus, the lighting test circuit 620 may provide an emission data voltage VEM to all the pixels PX.

In some embodiments, as illustrated in FIG. 19, in a second period after the first period within each of the first through P-th horizontal times HT1 through HTP, the pattern test circuit 660 may receive the first pattern test signal SPT1 having the on-level, and may not receive the second pattern test signal SPT2 having an on-level. Thus, the pattern test circuit 660 may provide the non-emission data voltage VNEM only to the pixels PX arranged in the first through (L/2)-th pixel columns PC1 through PCL/2. Accordingly, the display panel 600 may display a right region image 700 illustrated in FIG. 20 in a cell state in response to the lighting test signal SLT, the first pattern test signal SPT1, and the second pattern test signal SPT2 illustrated in FIG. 19.

In other embodiments, as illustrated in FIG. 21, in the second period after the first period within each of the first through P-th horizontal times HT1 through HTP, the pattern test circuit 660 may receive the second pattern test signal SPT2 having an on-level, and may not receive the first pattern test signal SPT1 having anon-level. Thus, the pattern test circuit 660 may provide the non-emission data voltage VNEM only to the pixels PX arranged in the (L/2+1)-th through L-th pixel columns PCL/2+1 through PCL. Accordingly, the display panel 600 may display a left region image 750 illustrated in FIG. 22 in a cell state in response to the lighting test signal SLT, the first pattern test signal SPT1, and the second pattern test signal SPT2 illustrated in FIG. 21.

As described above, in the display panel 600 according to embodiments, the lighting test circuit 620 may provide the emission data voltage VEM to the pixels PX, and the pattern test circuit 660 may provide the non-emission data voltage VNEM to a portion of the pixels PX. Accordingly, the display panel 600 according to embodiments may display the right region image 700 or the left region image 750 in a cell state, and thus a pattern test may be performed on the display panel 600 in a cell state.

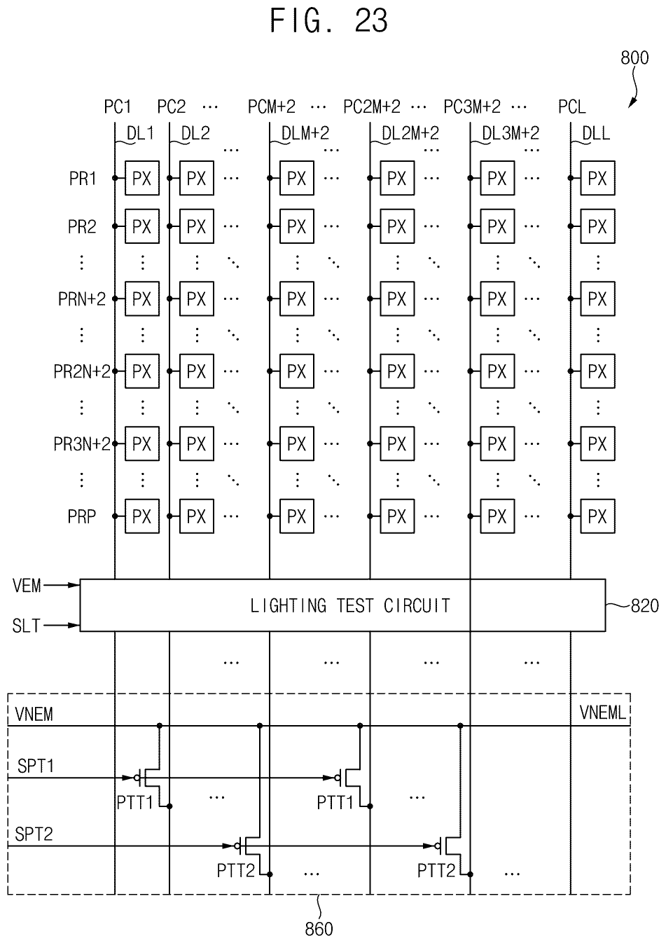

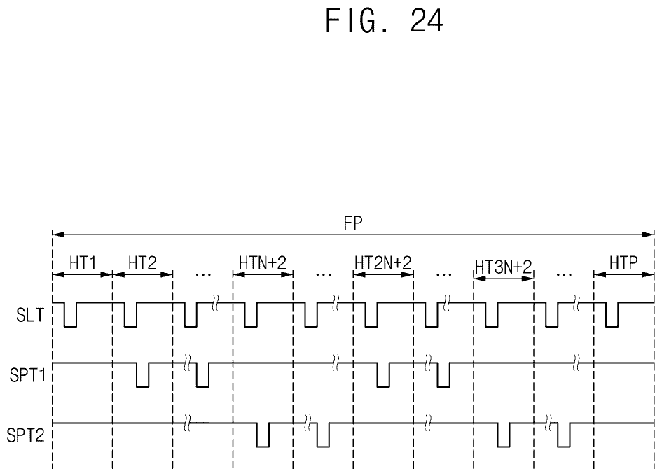

FIG. 23 is a schematic diagram illustrating a display panel according to embodiments, FIG. 24 is a schematic timing diagram for describing an operation of a display panel according to embodiments, and FIG. 25 is a schematic diagram illustrating a pattern image displayed by a display panel according to embodiments.

Referring to FIG. 23, a display panel 800 according to embodiments may include first through L-th data lines DL1 through DLL arranged in first through L-th pixel columns PC1 through PCL, multiple pixels PX, a lighting test circuit 820, and a pattern test circuit 860. In some embodiments, although it is not illustrated in FIG. 23, the display panel 800 may further include an open-short test circuit, a crack detection circuit, a one-sheet test circuit, etc.

The pattern test circuit 860 may include a non-emission data voltage line VNEML which transfers a non-emission data voltage VNEM, multiple first pattern test transistors PTT1 which connects the non-emission data voltage line VNEML to second through (M+1)-th data lines DL2, . . . arranged in second through (M+1)-th pixel columns PC2, . . . and (2M+2)-th through (3M+1)-th data lines DL2M+2, . . . arranged in (2M+2)-th through (3M+1)-th pixel columns PC2M+2, . . . , in response to a first pattern test signal SPT1, and multiple second pattern test transistors PTT2 which connects the non-emission data voltage line VNEML to (M+2)-th through (2M+1)-th data lines DLM+2, . . . arranged in (M+2)-th through (2M+1)-th pixel columns PCM+2, . . . and (3M+2)-th through (L−1)-th data lines DL3M+2, . . . arranged in (3M+2)-th through (L−1)-th pixel columns PC3M+2, . . . in response to a second pattern test signal SPT2. Thus, the pattern test circuit 860 may include no pattern test transistor which connects the non-emission data voltage line VNEML to the first and L-th data lines DL1 and DLL arranged in the first and L-th pixel columns PC1 and PCL.

The display panel 800 may include first through P-th pixel rows PR1, PR2, . . . , PRN+2, . . . , PR2N+2, . . . , PR3N+2, . . . , PRP. As illustrated in FIG. 24, the lighting test circuit 860 may receive a lighting test signal SLT having an on-level (e.g., a low level) in a first period within each of first through P-th horizontal times HT1, HT2, . . . , HTN+2, . . . , HT2N+2, . . . , HT3N+2, . . . , HTP allocated to the first through P-th pixel rows PR1 through PRP. Thus, the lighting test circuit 620 may provide an emission data voltage VEM to all the pixels PX. Further, the pattern test circuit 660 may receive the first pattern test signal SPT1 having an on-level in a second period after the first period within each of second through (N+1)-th horizontal times HT2, . . . and (2N+2)-th through (3N+1)-th horizontal times HT2N+2, . . . , may receive the second pattern test signal SPT2 having an on-level in a second period after the first period within each of (N+2)-th through (2N+1)-th horizontal times HTN+2, . . . and (3N+2)-th through (P−1)-th horizontal times HT3N+2, . . . , and may not receive any of the first pattern test signal SPT1 and the second pattern test signal SPT2 in the first and P-th horizontal times HT1 and HTP. Accordingly, the display panel 800 may display an image 890 in which a chess pattern image and an outer line image are combined as illustrated in FIG. 25 in a cell state in response to the lighting test signal SLT, the first pattern test signal SPT1, and the second pattern test signal SPT2 illustrated in FIG. 24.

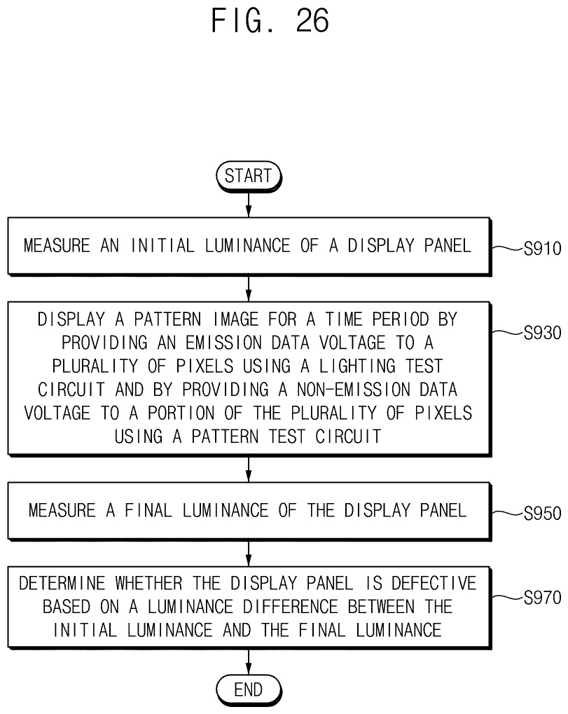

FIG. 26 is a flowchart illustrating a method of performing a pattern test for a display panel according to embodiments.

Referring to FIGS. 1 and 26, in a pattern test method for a display panel 100 according to embodiments, an initial luminance of the display panel 100 may be measured (S910). In some embodiments, the initial luminance of the display panel 100 may be measured when all pixels PX of the display panel 100 emit light based on an emission data voltage VEM.

A lighting test circuit 120 may provide the emission data voltage VEM to multiple pixels PX, and a pattern test circuit 160 may provide a non-emission data voltage VNEM to a portion of the pixels PX that has received the emission data voltage VEM. Thus, the pixels PX may display a pattern image for a certain time period (e.g., about ten minutes to about one hour) (S930). According to embodiments, the pattern image may be, but is not limited to, a chess pattern image illustrated in FIGS. 10 and 12, an outer line image illustrated in FIG. 15, a central region image illustrated in FIG. 17, a right region image illustrated in FIG. 20, a left region image illustrated in FIG. 22, or a combination of the chess pattern image and the outer line image illustrated in FIG. 25.

After the pixels PX displays a pattern image for a time period, a final luminance of the display panel 100 may be measured (S950). In some embodiments, the final luminance of the display panel 100 may be measured when all the pixels PX of the display panel 100 emit light based on the emission data voltage VEM.

Whether the display panel 100 is defective may be determined based on a luminance difference between the initial luminance and the final luminance (S970). For example, in case that the luminance difference between an initial luminance and a final luminance is greater than or equal to a reference luminance difference, the display panel 100 may be determined to be defective. In some embodiments, the pattern test method illustrated in FIG. 26 may be performed in a cell state before a data driver 190 is connected to the display panel 100. Further, in some embodiments, before or after the pattern test method illustrated in FIG. 26 is performed, a lighting test, an open-short test, etc. may be further performed on the display panel 100 in a cell state. Further, after the pattern test method illustrated in FIG. 26 is performed, the display panel 100 may be connected to the data driver 190.

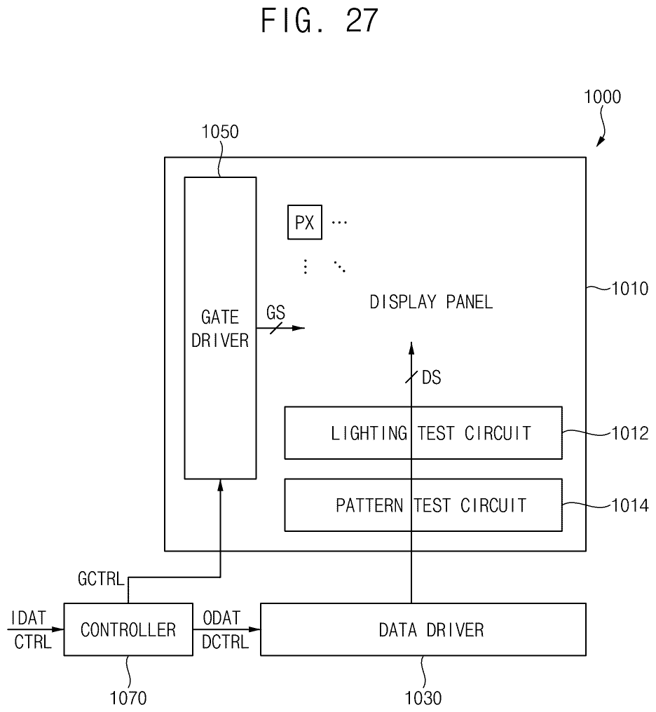

FIG. 27 is a schematic block diagram illustrating a display device according to embodiments.

Referring to FIG. 27, a display device 1000 may include a display panel 1010 that includes multiple pixels PX, a data driver 1030 that provides data signals DS to the pixels PX, a gate driver 1050 that provides gate signals GS to the pixels PX, and a controller 1070 that controls the data driver 1030 and the gate driver 1050.

The display panel 1010 may include the pixels PX, a lighting test circuit 1012 and a pattern test circuit 1014. While the display device 1000 is manufactured, the lighting test circuit 1012 and the pattern test circuit 1014 may be used to perform a lighting test and/or a pattern test. After the display device 1000 is manufactured, the lighting test circuit 1012 and the pattern test circuit 1014 may not operate. According to embodiments, the display panel 1010 may be a display panel 100 of FIG. 1, a display panel 200 of FIG. 8, a display panel 400 of FIG. 13, a display panel 600 of FIG. 18, a display panel 800 of FIG. 23, or a similar display panel. In some embodiments, although it is not illustrated in FIG. 27, the display panel 1010 may further include an open-short test circuit, a crack detection circuit, a one-sheet test circuit, etc.

The data driver 1030 may provide the data signals DS to the pixels PX based on output image data ODAT and a data control signal DCTRL received from the controller 1070. In some embodiments, the data control signal DCTRL may include, but is not limited to, an output data enable signal, a horizontal start signal and a load signal. In some embodiments, the data driver 1030 and the controller 1070 may be implemented as a single integrated circuit, and the single integrated circuit may be referred to as a timing controller embedded data driver (“TED”) integrated circuit. In other embodiments, the data driver 1030 and the controller 1070 may be implemented as separate integrated circuits.

The gate driver 1050 may provide the gate signals GS to the pixels PX based on a gate control signal GCTRL received from the controller 1070. In some embodiments, the gate control signal GCTRL may include, but is not limited to, a start signal and a clock signal. Further, in some embodiments, as illustrated in FIG. 27, the gate driver 1050 may be integrated or formed in the display panel 1010. In other embodiments, the gate driver 1050 may be implemented with one or more integrated circuits.

The controller 1070 (e.g., a timing controller) may receive input image data IDAT and a control signal CTRL from an external processor (e.g., an application processor (“AP”), a graphics processing unit (“GPU”) or a graphics card). In some embodiments, the control signal CTRL may include, but is not limited to, a vertical synchronization signal, a horizontal synchronization signal, an input data enable signal, a master clock signal, etc. The controller 1070 may generate the output image data ODAT, the data control signal DCTRL and the gate control signal GCTRL based on the input image data IDAT and the control signal CTRL. The controller 1070 may control the data driver 1030 by providing the output image data ODAT and the data control signal DCTRL to the data driver 1030, and may control the gate driver 1050 by providing the gate control signal GCTRL to the gate driver 1050.

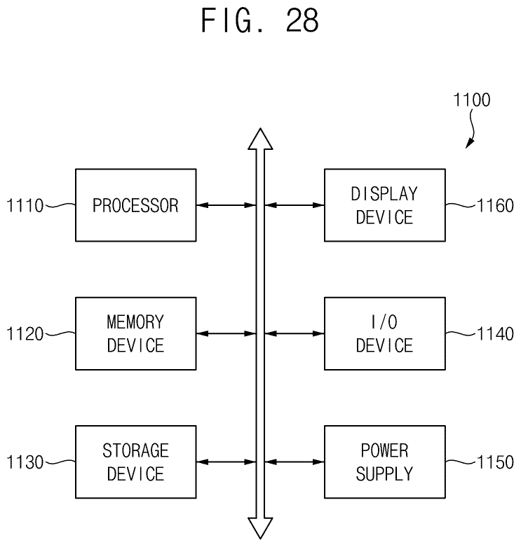

FIG. 28 is a schematic block diagram illustrating an electronic device including a display device according to embodiments.

Referring to FIG. 28, an electronic device 1100 may include a processor 1110, a memory device 1120, a storage device 1130, an input/output (“I/O”) device 1140, a power supply 1150 and a display device 1160. The electronic device 1100 may further include multiple ports for communicating with a video card, a sound card, a memory card, a universal serial bus (“USB”) device, other electric devices, etc.

The processor 1110 may perform various computing functions or tasks. The processor 1110 may be an application processor (“AP”), a micro-processor, a central processing unit (“CPU”), etc. The processor 1110 may be coupled to other components via an address bus, a control bus, a data bus, etc. In some embodiments, the processor 1110 may be further coupled to an extended bus such as a peripheral component interconnection (“PCI”) bus.

The memory device 1120 may store data for operations of the electronic device 1100. For example, the memory device 1120 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, etc., and/or at least one volatile memory device such as a dynamic random access memory (“DRAM”) device, a static random access memory (“SRAM”) device, a mobile dynamic random access memory (“mobile DRAM”) device, etc.

The storage device 1130 may be a solid state drive (“SSD”) device, a hard disk drive (“HDD”) device, a compact disc-read only memory (“CD-ROM”) device, etc. The I/O device 1140 may be an input device such as a keyboard, a keypad, a mouse, a touch screen, etc., and an output device such as a printer, a speaker, etc. The power supply 1150 may supply power for operations of the electronic device 1100. The display device 1160 may be coupled to other components through buses or other communication links.

In a manufacturing process of the display device 1160, a lighting test circuit of a display panel may provide an emission data voltage to multiple pixels, and a pattern test circuit of the display panel may provide a non-emission data voltage to a portion of the pixels. Accordingly, the display panel included in the display device 1160 according to embodiments may display a pattern image in a cell state, and thus a pattern test may be performed on the display panel in a cell state.

The disclosure may be applied to any electronic device 1100 including the display device 1160. For example, the disclosure may be applied to a mobile phone, a smart phone, a virtual reality (“VR”) device, a television (“TV”) (e.g., a digital TV, a three-dimensional (“3D”) TV, etc.), a wearable electronic device, a personal computer (“PC”) (e.g. a laptop computer, a tablet computer, etc.), a home appliance, a personal digital assistant (“PDA”), a portable multimedia player (“PMP”), a digital camera, a music player, a portable game console, a navigation device, etc.

The above description is an example of technical features of the disclosure, and those skilled in the art to which the disclosure pertains will be able to make various modifications and variations. Thus, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A display panel comprising:
a plurality of data lines;
a plurality of pixels connected to the plurality of data lines;
a lighting test circuit that provides an emission data voltage to the plurality of pixels through the plurality of data lines; and
a pattern test circuit that provides a non-emission data voltage to a portion of the plurality of pixels through the plurality of data lines after the emission data voltage is provided to the plurality of pixels such that the plurality of pixels displays a pattern image.

2. The display panel of claim 1, wherein
the lighting test circuit provides the emission data voltage to the plurality of pixels arranged in a pixel row in a first period within a horizontal time allocated to the pixel row, and
the pattern test circuit provides the non-emission data voltage to a portion of the plurality of pixels arranged in the pixel row in a second period after the first period within the horizontal time.

3. The display panel of claim 1, wherein the lighting test circuit includes:
an emission data voltage line that transfers the emission data voltage; and
a plurality of lighting test transistors that connect the emission data voltage line to the plurality of data lines in response to a lighting test signal.

4. The display panel of claim 1, wherein
the plurality of pixels includes red pixels arranged in a first pixel column, green pixels arranged in a second pixel column, and blue pixels arranged in a third pixel column, and
the lighting test circuit includes:
a red emission data voltage line that transfers a red emission data voltage to the red pixels;
a green emission data voltage line that transfers a green emission data voltage to the green pixels;
a blue emission data voltage line that transfers a blue emission data voltage to the blue pixels;
a first lighting test transistor that connects the red emission data voltage line to a data line arranged in the first pixel column among the plurality of data lines in response to a lighting test signal;
a second lighting test transistor that connects the green emission data voltage line to a data line arranged in the second pixel column among the plurality of data lines in response to the lighting test signal; and
a third lighting test transistor that connects the blue emission data voltage line to a data line arranged in the third pixel column among the plurality of data lines in response to the lighting test signal.

5. The display panel of claim 1, wherein
the plurality of pixels includes:
red, green, blue and green pixels arranged in a first pixel row and arranged in first, second, third, and fourth pixel columns, respectively; and
blue, green, red and green pixels arranged in a second pixel row adjacent to the first pixel row and arranged in the first, second, third, and fourth pixel columns, respectively, and
the lighting test circuit includes:
a red emission data voltage line that transfers a red emission data voltage;
a green emission data voltage line that transfers a green emission data voltage;
a blue emission data voltage line that transfers a blue emission data voltage;
a first-first lighting test transistor that connects the red emission data voltage line to a data line arranged in the first pixel column among the plurality of data lines in response to a first lighting test signal;
a first-second lighting test transistor that connects the blue emission data voltage line to the data line arranged in the first pixel column among the plurality of data lines in response to a second lighting test signal;
a second lighting test transistor that connects the green emission data voltage line to a data line arranged in the second pixel column among the plurality of data lines in response to a third lighting test signal;
a third-first lighting test transistor that connects the blue emission data voltage line to a data line arranged in the third pixel column among the plurality of data lines in response to the first lighting test signal;
a third-second lighting test transistor that connects the red emission data voltage line to the data line arranged in the third pixel column among the plurality of data lines in response to the second lighting test signal; and
a fourth lighting test transistor that connects the green emission data voltage line to a data line arranged in the fourth pixel column among the plurality of data lines in response to the third lighting test signal.

6. The display panel of claim 5, wherein the lighting test circuit receives the first lighting test signal and the third lighting test signal within a first horizontal time for the first pixel row, and receives the second lighting test signal and the third lighting test signal within a second horizontal time for the second pixel row.

7. The display panel of claim 1, wherein the pattern test circuit includes:
a non-emission data voltage line that transfers the non-emission data voltage;
a plurality of first pattern test transistors that connect the non-emission data voltage line to a portion of the plurality of data lines in response to a first pattern test signal; and
a plurality of second pattern test transistors that connect the non-emission data voltage line to a remainder of the plurality of data lines in response to a second pattern test signal.

8. The display panel of claim 7, wherein
the lighting test circuit receives a lighting test signal in a first period within each horizontal time, and
the pattern test circuit receives one of the first pattern test signal and the second pattern test signal in a second period after the first period within the each horizontal time.

9. The display panel of claim 1, wherein
the plurality of data lines includes:
first through M-th data lines arranged in first through M-th pixel columns, respectively;
(M+1)-th through 2M-th data lines arranged in (M+1)-th through 2M-th pixel columns, respectively;
(2M+1)-th through 3M-th data lines arranged in (2M+1)-th through 3M-th pixel columns, respectively; and
(3M+1)-th through 4M-th data lines arranged in (3M+1)-th through 4M-th pixel columns, respectively,
M is an integer greater than 0, and
the pattern test circuit includes:
a non-emission data voltage line that transfers the non-emission data voltage;
a plurality of first pattern test transistors that connect the non-emission data voltage line to the first through M-th data lines and the (2M+1)-th through 3M-th data lines in response to a first pattern test signal; and
a plurality of second pattern test transistors that connect the non-emission data voltage line to the (M+1)-th through 2M-th data lines and the (3M+1)-th through 4M-th data lines in response to a second pattern test signal.

10. The display panel of claim 9, wherein
the lighting test circuit receives a lighting test signal in a first period within each of first through N-th horizontal times allocated to first through N-th pixel rows, (N+1)-th through 2N-th horizontal times allocated to (N+1)-th through 2N-th pixel rows, (2N+1)-th through 3N-th horizontal times allocated to (2N+1)-th through 3N-th pixel rows, and (3N+1)-th through 4N-th horizontal times allocated to (3N+1)-th through 4N-th pixel rows,
N is an integer greater than 0,
the pattern test circuit receives the second pattern test signal in a second period after the first period within each of the first through N-th horizontal times and the (2N+1)-th through 3N-th horizontal times, and receives the first pattern test signal in a second period after the first period within each of the (N+1)-th through 2N-th horizontal times and the (3N+1)-th through 4N-th horizontal times, and
the pattern image is a chess pattern image.

11. The display panel of claim 9, wherein
the lighting test circuit receives a lighting test signal in a first period within each of first through N-th horizontal times allocated to first through N-th pixel rows, (N+1)-th through 2N-th horizontal times allocated to (N+1)-th through 2N-th pixel rows, (2N+1)-th through 3N-th horizontal times allocated to (2N+1)-th through 3N-th pixel rows, and (3N+1)-th through 4N-th horizontal times allocated to (3N+1)-th through 4N-th pixel rows,
N is an integer greater than 0,
the pattern test circuit receives the first pattern test signal in a second period after the first period within each of the first through N-th horizontal times and the (2N+1)-th through 3N-th horizontal times, and receives the second pattern test signal in a second period after the first period within each of the (N+1)-th through 2N-th horizontal times and the (3N+1)-th through 4N-th horizontal times, and
the pattern image is a chess pattern image.

12. The display panel of claim 1, wherein
the plurality of data lines includes first through L-th data lines arranged in first through L-th pixel columns,
L is an integer greater than 0,
the pattern test circuit includes:
a non-emission data voltage line that transfers the non-emission data voltage;
a plurality of first pattern test transistors that connect the non-emission data voltage line to (K+1)-th through (L−K)-th data lines among the first through L-th data lines in response to a first pattern test signal; and
a plurality of second pattern test transistors that connect the non-emission data voltage line to first through K-th data lines and (L−K+1)-th through L-th data lines among the first through L-th data lines in response to a second pattern test signal, and
K is an integer greater than 0 and less than L/2.

13. The display panel of claim 12, wherein
the display panel includes first through P-th pixel rows,
P is an integer greater than 0,
the lighting test circuit receives a lighting test signal in a first period within each of first through P-th horizontal times allocated to the first through P-th pixel rows,
the pattern test circuit does not receive any of the first pattern test signal and the second pattern test signal in each of first through Q-th horizontal times and (P−Q+1)-th through P-th horizontal times among the first through P-th horizontal times, and receives the first pattern test signal in a second period after the first period within each of (Q+1)-th through (P−Q)-th horizontal times among the first through P-th horizontal times,
Q is an integer greater than 0 and less than P/2, and
the pattern image is an outer line image.

14. The display panel of claim 12, wherein
the display panel includes first through P-th pixel rows,
P is an integer greater than 0,
the lighting test circuit receives a lighting test signal in a first period within each of first through P-th horizontal times allocated to the first through P-th pixel rows,
the pattern test circuit receives both of the first pattern test signal and the second pattern test signal in each of first through Q-th horizontal times and (P−Q+1)-th through P-th horizontal times among the first through P-th horizontal times, and receives the second pattern test signal in a second period after the first period within each of (Q+1)-th through (P−Q)-th horizontal times among the first through P-th horizontal times,
Q is an integer greater than 0 and less than P/2, and
the pattern image is a central region image.

15. The display panel of claim 1, wherein
the plurality of data lines includes first through L-th data lines arranged in first through L-th pixel columns, respectively,
L is an integer greater than 0, and
the pattern test circuit includes:
a non-emission data voltage line that transfers the non-emission data voltage;
a plurality of first pattern test transistors that connect the non-emission data voltage line to first through (L/2)-th data lines among the first through L-th data lines in response to a first pattern test signal; and
a plurality of second pattern test transistors that connect the non-emission data voltage line to (L/2+1)-th through L-th data lines among the first through L-th data lines in response to a second pattern test signal.

16. The display panel of claim 15, wherein
the lighting test circuit receives a lighting test signal in a first period within each horizontal time,
the pattern test circuit receives the first pattern test signal in a second period after the first period within the each horizontal time, and
the pattern image is a right region image.

17. The display panel of claim 15, wherein
the lighting test circuit receives a lighting test signal in a first period within each horizontal time,
the pattern test circuit receives the second pattern test signal in a second period after the first period within the each horizontal time, and
the pattern image is a right region image.

18. The display panel of claim 1, further comprising:
an open-short test circuit that alternately provides a first open-short test voltage and a second open-short test voltage to the plurality of data lines,
wherein the non-emission data voltage is the first open-short test voltage of the open-short test circuit.

19. A method of performing a pattern test for a display panel, the method comprising:
measuring an initial luminance of the display panel;
displaying, by a plurality of pixels of the display panel, a pattern image for a time period by providing an emission data voltage to the plurality of pixels by using a lighting test circuit of the display panel and by providing a non-emission data voltage to a portion of the plurality of pixels that have received the emission data voltage by using a pattern test circuit of the display panel;
measuring a final luminance of the display panel; and
detecting whether the display panel is defective based on a luminance difference between the initial luminance and the final luminance.

20. An electronic device, comprising:
a processor that provides image data; and
a display device that displays an image based on the image data,
wherein the display device includes the display panel according to claim 1.
